(19) United States
(12) Patent Application Publication
(10) Pub. No.: US 2025/0131750 A1
(43) Pub. Date: Apr. 24, 2025

(54) BIOLOGICAL FLUID ANALYSER WITH LIGHT-SETTING-BASED CELL CLASSIFICATION

(71) Applicant: Radiometer Medical ApS, Brønshøj (DK)

(72) Inventors: Peter Emil LARSEN, Brønshøj (DK); Thomas Steen HANSEN, Brønshøj (DK); Willy Lindegaard ANDERSEN, Brønshøj (DK); Mohammad Esmail ARYAEE PANAH, Brønshøj (DK)

(21) Appl. No.: 18/722,133

(22) PCT Filed: Dec. 22, 2022
(86) PCT No.: PCT/EP2022/087491

§ 371 Date: Jun. 20, 2024

(30) Foreign Application Priority Data
Dec. 23, 2021 (EP) 21217285.2

(51) Int. Cl. G06V 20/69; G01N 15/1433; G06V 10/14; G06V 10/764

(52) U.S. Cl. CPC G06V 20/698; G01N 15/1433; G06V 10/14; G06V 10/764; G06V 20/693; G06V 20/695

(57) ABSTRACT

A biological fluid analyser is disclosed. The biological fluid analyser is configured to obtain image data of one or more image planes of an image stack in a prepared biological fluid sample. The image data comprises first image data associated with a first image plane. To obtain the first image data comprises to obtain first primary image data of the first image plane. The first primary image data is associated with a first incident light setting. The first incident light setting has a first angular light distribution. To obtain the first image data comprises to obtain first secondary image data of the first image plane. The first secondary image data is associated with a second incident light setting. The second incident light setting has a second angular light distribution. The biological fluid analyser is configured to classify, based on the first primary image data and the first secondary image data, a cell in the prepared biological fluid sample for provision of a cell parameter associated with the cell.

The present disclosure relates to analysis of biological fluid samples, such as blood samples or cell culture samples, and related tools, methods, and systems in particular with light-setting-based cell classification. Thus, a biological fluid analyser and related methods, in particular a method with light-setting-based cell classification is provided.

### BACKGROUND

Today the analysis of a biological fluid sample, such as determining a cell type, such as classifying a cell, may require numerous steps, preparation, resources, and various advanced equipment. Haematology measurements or other cell-based measurements may rely on a differentiation of different cell types, such as differentiation of different white blood cells (e.g., leucocyte types). The process of identifying cells is to a large degree based on identifying certain features of the cell, e.g., number of lobes of a nucleus, size, shape and/or texture of a cell membrane, texture and/or area of a cytoplasm.

It may be challenging to find an optimum between a quality of optics, e.g., how many details on a cell can be observed, cost, e.g., better quality is more expensive, and/or magnification, e.g., better magnification may give more details, but fewer cells can be imaged. This trade-off off and optical specifications may lead to a situation where the level of detail in the cell images is not sufficient to reliably differentiate cell types from each other.

### SUMMARY

Accordingly, there is a need for biological fluid analysers and related methods, in particular methods of analysing a biological fluid sample with improved biological fluid sample analysis, differentiation of cells, and accuracy.

A biological fluid analyser is disclosed. The biological fluid analyser comprises a memory, an interface, and one or more processors. The biological fluid analyser is configured to obtain image data of one or more image planes of an image stack in a prepared biological fluid sample, such as a blood sample or a cell culture sample. The image data comprises first image data associated with a first image plane. To obtain the first image data comprises to obtain first primary image data of the first image plane. The first primary image data is associated with a first incident light setting. The first incident light setting may optionally have a first angular light distribution. To obtain the first image data comprises to obtain first secondary image data of the first image plane. The first secondary image data is associated with a second incident light setting. The second incident light setting may optionally have a second angular light distribution. The biological fluid analyser is configured to classify, based on the first primary image data and/or the first secondary image data, a cell in the prepared biological fluid sample, such as a blood sample or a cell culture sample, for provision of a cell parameter associated with the cell.

Further, a method for classifying a cell in a prepared biological fluid sample, such as a blood sample or a cell culture sample, is disclosed. The method comprises obtaining image data of one or more images planes in an image stack of the prepared biological fluid sample, such as a blood sample or a cell culture sample, the image data comprising first image data associated with a first image plane. Obtaining the first image data comprises obtaining first primary image data of the first image plane. The first primary image data is associated with a first incident light setting having a first angular light distribution. Obtaining the first image data comprises obtaining first secondary image data of the first image plane. The first secondary image data is associated with a second incident light setting having a second angular light distribution. The method comprises classifying, based on the first primary image data and the first secondary image data, a cell in the prepared biological fluid sample, such as a blood sample or a cell culture sample. The method comprises providing, based on the classification of the cell, a cell parameter associated with the cell. The method may be performed using a biological fluid analyser as disclosed herein.

Also disclosed is a system comprising a microscope, an imaging system, an image acquiring device, a biological fluid sample cavity for accommodating a prepared biological fluid sample, such as a blood sample or a cell culture sample, and a biological fluid analyser, wherein the biological fluid analyser is a biological fluid analyser according to the present disclosure. Optionally, the system comprises an imaging system. The imaging system may comprise one or more of a light source assembly configured to emit light, a lens assembly configured to direct the light from the light source assembly, and an aperture device configured to apply an aperture to allow light from the lens assembly to pass through the aperture in order to indirectly define a probing light.

It is an advantage of the present disclosure that an improved biological fluid analysis is provided. The present disclosure provides an improved cell classification, such as an improved single cell classification with light-setting-based cell classification.

For example, a more efficient, accurate, precise, and robust, image-based cell parameter determination may be achieved, e.g., cell classification and/or single cell classification, such as the determination of a white blood cell, WBC, type, and/or a cell concentration in a biological fluid sample, such as a concentration of WBC, platelets, and/or of special pathological cell types. Further, an improved cell classification with higher accuracy is provided, and in particular improved cell analysis, such as cell classification, e.g., white blood cell analysis and/or classification. By classifying cells based on image data obtained with different incident light settings, such as first primary image data and first secondary image data, the present disclosure provides classification based on more information, such as additional cell information, than known techniques. The present disclosure may thereby take different incident light settings into account when classifying cells of a biological fluid sample. In other words, the present disclosure may provide a light-setting-based cell classification.

It is an advantage of the present disclosure that it provides a more detailed, efficient, precise, and customized, biological fluid sample analysis. For example, it may be possible to determine cell parameters, such as classify cells, count cells, such as white blood cells, in one or few image planes. It is an advantage of the present disclosure that it provides an improved cell differentiation, such as an improved differentiation of white blood cells. It may therefore be possible to detect an anomaly in a biological fluid sample in a more precise manner. The present disclosure may also alleviate the challenges related to the trade-off between quality of optics, cost, magnification, and/or optical specifications, e.g., by providing an improved cell differentiation also with limited equipment quality and/or cost.

### BRIEF DESCRIPTION OF THE DRAWINGS

The above and other features and advantages of the present invention will become readily apparent to those skilled in the art by the following detailed description of exemplary embodiments thereof with reference to the attached drawings, in which:

FIG. 1 schematically illustrates a block diagram of an exemplary biological fluid analyser according to the present disclosure,

FIG. 2 schematically illustrates an exemplary system comprising an exemplary biological fluid analyser according to the present disclosure,

FIG. 3 schematically illustrates an exemplary system comprising an exemplary imaging system,

FIG. 4 is a flow diagram of an exemplary method according to the present disclosure, and

FIGS. 5-9 show exemplary images of cells (such as cell regions) obtained in different image planes and obtained with different incident light settings, where an exemplary method and/or biological fluid analyser according to the present disclosure are carried out and/or used.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

In the following, whenever referring to proximal side of an image plane, the referral is to the side closest to or the surface facing a camera or sensor (e.g. of a microscope), when an image is obtained/captured. Likewise, whenever referring to the distal side of an image plane, the referral is to the side furthest away from or the surface facing away from the camera or sensor, when an image is obtained/captured. In other words, the proximal side or surface is the side or surface closest to the camera or sensor, when an image is obtained/captured, and the distal side is the opposite side or surface with respect to the image plane. In other words, the distal side may be the side or surface closest to the bottom of a container containing the prepared biological fluid sample, such as a blood sample or a cell culture sample, when an image is obtained/captured. A stack of images, such as a stack of image planes, may be seen as comprising one or more slices of a sample of images. The light sensor may be an image sensor, e.g., with a pixel resolution of at least 1 mega pixel. In one or more example biological fluid analysers, the camera or light sensor is configured to be non-exchangeable. By non-exchangeable is meant that the camera or light sensor is at least not directly accessible during normal operation of the biological fluid analyser and cannot be removed without the removal of parts of the biological fluid analyser separate from the camera or light sensor, such as, e.g., removal of panels for light shielding. This improves the simplicity of the biological fluid analyser and allows for a relatively compact design, as it is not necessary to allow users to easily access and replace the camera or light sensor.

A biological fluid analyser is disclosed. The biological fluid analyser comprises a memory, an interface, and one or more processors. The biological fluid analyser may comprise an electronic device such as a computer, e.g., a laptop computer or PC, a tablet computer, and/or a mobile phone, such as a smartphone. The biological fluid analyser may for example be a point of care (POC) device. The biological fluid analyser may for example be configured to be integrated with a blood gas analyser. The biological fluid analyser may for example be a user device, such as a computer or a mobile phone, configured to perform an analysis of a biological fluid sample, such as a prepared biological fluid sample, such as a blood sample or a cell culture sample. The biological fluid analyser may for example be part of the equipment in a laboratory. The biological fluid analyser may for example be used as an instrument near the patients, such as a point of care device. The biological fluid analyser may be configured to perform haematology measurements and/or analysis.

The biological fluid analyser may be a blood analyser. In other words, the biological fluid analyser may be configured to analyse human blood and/or animal blood, such as, e.g., mammal blood. Thus, the prepared biological fluid sample may be a prepared blood sample.

The biological fluid analyser may be a cell culture analyser. In other words, the biological fluid analyser may be configured to analyse cell cultures, such, e.g., culture of cells derived from multicellular eukaryotes, such as, e.g., mammalian cells, animal cells, and/or human cells; and/or culture of cells grown from plant tissue culture, fungal culture, and/or microbiological culture (of microbes). Thus, the prepared biological fluid sample may be a prepared cell culture sample.

In one or more exemplary biological fluid analysers, the biological fluid analyser is a server device, such as acting as a server device. In other words, the biological fluid analyser may be seen as implemented on a server device, such as the biological fluid analyser may be configured to run and/or operate on a server device. The biological fluid analyser acting as server device may be seen as a device configured to act as a server in communication with a client device, such as a computer, e.g., a laptop computer or PC, a tablet computer, and/or a mobile phone, such as a smartphone. For example, the biological fluid analyser may be a remote server device configured to communicate with a client device. The biological fluid analyser acting as server device may for example be configured to perform any one or more of: obtain image data, such as first image data, obtain first primary image data, obtain first secondary image data, classify a cell in a prepared biological fluid sample, such as a blood sample or a cell culture sample, and providing a cell parameter associated with the cell. The biological fluid analyser acting as server device may for example be configured to output the cell parameter to a client device.

In one or more example biological fluid analysers, the biological fluid analyser is configured to obtain first secondary image data less than 20 seconds after obtaining first primary image data, such as less than 10 seconds, such as less than 5 seconds, such as less than 1 second. This allows for relatively rapid obtainment of first primary image data and first secondary image data, which in turn further improves the possibility of obtaining first primary image data and first secondary image data on at least partially the same prepared biological fluid sample volume.

In one or more example biological fluid analysers, the first primary image data is obtained on a first probing volume, wherein the first secondary image data is obtained on a second probing volume, and wherein at least part of the first and second probing volumes overlap. In some examples, at least 90%, at least 70%, or least 50% of the first and second probing volumes overlap. The biological fluid analyser may be configured to keep the probing volume, and potentially also the container, stationary during, e.g., change from the first aperture configuration to the second aperture configuration. Additionally, or alternatively, this allows imaging of at least part of the same volume of the prepared biological fluid with the aperture device in the first aperture configuration and the second aperture configuration. This may be particularly advantageous in combination with example biological fluid analysers, wherein the imaging system is configured to selectively provide first probing light comprising light with only incident light angle within the first light angle range and/or the imaging system is configured to selectively provide second probing light comprising light with only incident light angle within the second light angle range as this allows effective acquiring of image data of at least part of the same volume of prepared biological fluid sample acquired with different incident light angles.

In one or more example biological fluid analysers, the biological fluid analyser defines an optical path corresponding to that of a transmission microscope. In other words, the imaging system may be configured to obtain image data from probing light having been transmitted through the probing volume. This allows imaging of the prepared body fluid sample without having to rely solely on florescence emitted by the prepared fluid analyser. Additionally, this may allow improved simplicity and reduced footprint of the biological fluid analyser, which may be particularly useful for cell classification, particularly in a point of care and/or bedside setting. Additionally, it may allow the biological fluid analyser to obtain an image stack of images planes for richer image data and potentially improved cell classification.

The biological fluid analyser is configured to obtain image data, also denoted ID, of one or more image planes of an image stack in a prepared biological fluid sample, such as a blood sample or a cell culture sample. Image data may comprise one or more images, such as a plurality of images, e.g., a stack of images and/or an image stack. The image data may comprise a plurality of images of the prepared biological fluid sample, such as a blood sample or a cell culture sample, obtained with a microscope and a camera, such as a CMOS image sensor camera. The image data may for example at least comprise ten images, at least twenty images, at least thirty images, at least forty images, at least fifty images, or at least a hundred images. The images of the image data may have an area depending on the area of the camera image sensor and a microscope magnification, e.g., A=A_im/M², where A is the area of the captured image, M is the microscope magnification of the microscope, and A_im is the area of the camera image sensor. The images of the image data may have a pixel size in the range of 0.1 μm to 5 μm, such as 0.5 μm, 1 μm, or 2 μm, depending on the resolution of the camera and the objective used. The image data may comprise a plurality of images of the prepared biological fluid sample, such as a blood sample or a cell culture sample, where each image of the plurality of images is associated with an image plane of the prepared biological fluid sample, such as a blood sample or a cell culture sample. The microscope and camera may obtain/acquire the plurality of images by stepping an optical focus plane along a z-axis, such as in a vertical direction of the prepared biological fluid sample, such as a blood sample or a cell culture sample. The image data may therefore comprise a plurality of images being associated with images planes, where each image plane is separated by a distance Δz to the next obtained/acquired image plane and/or the previous obtained/acquired image plane. Δz may be the stepping incrimination for each obtained/acquired image. For example, the image data may comprise a plurality of images of the prepared biological fluid sample, such as a blood sample or a cell culture sample, where each image may be associated with an image plane being equidistant from the next obtained/acquired image plane and/or the previous obtained/acquired image plane. In other words, the image data may comprise a 3D image stack, such as a stack of images where each image of the image stack is associated with an image plane having a different associated height along the z-axis of the prepared biological fluid sample, such as a blood sample or a cell culture sample. In other words, each image plane may be associated with a unique height in the prepared biological fluid sample, such as a blood sample or a cell culture sample, contained in a container, e.g., the prepared biological fluid sample, such as a blood sample or a cell culture sample, contained in a cuvette. The distance between two image planes may be denoted inter-image distance. The distance between two image planes may vary, for example, depending on the type of cell of interest. The distance between two image planes may also, for example, vary depending on the numerical aperture, NA, and therefore also the depth of field, DOF, of the microscope which is used. This may be to achieve an image in the image stack, where the cell has the best focus. The distance between two image planes may for example be in the range of 1 μm to 10 μm, such as in the range of 2 μm to 8 μm, in the range of 3 μm to 6 μm, in the range of 1 μm to 8 μm, and/or in the range of 1 μm to 6 μm, e.g., when the cell of interest is a platelet, e.g., since platelets have a diameter in the range of 1 μm to 5 μm, such as in the range of 2 μm to 3 μm. The distance between two image planes may for example be 5.04 μm, e.g., when the cell of interest is platelets, e.g., since platelets have a diameter in the range of 1 μm to 5 μm, such as in the range of 2 μm to 3 μm. The distance between two image planes may for example be in the range of 4 μm to 15 μm, such as in the range of 5 μm to 12 μm, in the range of 5 μm to 10 μm, in the range of 8 μm to 12 μm, and/or in the range of 9 μm to 11 μm, e.g., when the cell of interest is a white blood cell. For example, the distance between two image planes may for example be 4 μm, 5 μm, 6 μm, 7 μm, 8 μm, 9 μm, 10 μm and/or 11 μm. For example, a white blood cell having a diameter in the range, e.g., of 5 μm to 10 μm may belong to two image planes. The image data may comprise a plurality of images of a central portion of the biological fluid sample (such as the prepared biological fluid sample, such as a blood sample or a cell culture sample). In other words, the image data may comprise a plurality of obtained/acquired images of the prepared biological fluid sample, such as a blood sample or a cell culture sample, representing areas or volumes of the prepared biological fluid sample, such as a blood sample or a cell culture sample, being located away from the edges of the container in which the prepared biological fluid sample, such as a blood sample or a cell culture sample, is contained. An advantage of having images of the prepared biological fluid sample representing areas or volumes of the prepared biological fluid sample being located away from the edges of the container in which the prepared biological fluid sample is contained may be to avoid seeing the edges of the glass of the container, such as dirt on the glass of the container. In one or more exemplary biological fluid analysers, the image data, such as one or more images of the image data, may be cropped. For example, an image taken with a resolution of 20 megapixels may be cropped by cropping 20% of the side length of the field of view, FOV. The cropped image may be of a central portion of the biological fluid sample, such as a reduced part of the FOV. A central portion of the biological fluid sample may have the best optical resolution and have the least optical aberration. An advantage of using cropped images may be that a larger number of images may be selected from the image data. For example, substantially all the images of the image data may be selected, such as at least 20 images, at least 30 images, or at least 40 images. By selecting more images, it may be possible to compensate for an inaccurate distance travel in a focus mechanism (such as a mechanical delta Z movement) of a microscope. A further advantage of using cropped images is that the computing resources for characterizing images, such as determining a set of cell regions, is reduced.

Each image of the image data ID may comprise a plurality of representations. The plurality of representations may comprise a plurality of particles, such as cells, e.g., white blood cells, WBCs, platelets, PLTs, red blood cells, RBCs, clots of blood components, cell debris, and/or external particles, e.g., dust, precipitation, or residues from the container or the like. The plurality of representations may comprise a plurality of cells, e.g., mature cells such as Reticulocytes (slightly immature RBCs), Lymphocytes, and/or Monocytes, segmented and band-shaped Granulocytes (slightly immature neutrophils): Neutrophil, Eosinophil, and/or Basophil, and immature cells such as Normoblasts, erythroblasts, proerythroblasts, Metamyelocytes, Myelocytes, Promyelocytes, Myeloblasts, Monoblasts, and/or Lymphoblasts.

The prepared biological fluid sample may comprise a biological fluid sample prepared with one or more reagents, chemicals, treatments, and/or processes. The prepared biological fluid sample may for example comprise a biological fluid sample which has been stained, such as chemically stained. The prepared biological fluid sample may for example comprise a biological fluid sample which has been positioned/fixed, such that substantially no cell movement occurs while obtaining/acquiring the images of the prepared biological fluid sample. The prepared biological fluid sample may be understood as a solution comprising biological fluid and one or more reagents and/or chemicals. The prepared biological fluid sample may be understood as a dissolution, e.g., a dissolved biological fluid sample. The prepared biological fluid sample may be placed/positioned in a container, such as a cuvette, while the image data, e.g., the plurality of images of the prepared biological fluid sample, is obtained/acquired. The height that the image planes are associated with may be a height or distance, e.g., on the z-axis, with respect to the bottom of the container/cuvette or with respect to the camera/microscope, when the image was obtained/captured. The image planes that the plurality of images may extend in a two-dimensional plane, e.g., a x-y-plane perpendicular with respect to the z-axis.

In example biological fluid analysers, wherein the cuvette is a multi-use cuvette, the biological fluid analyser may be configured as a multi-use device comprising the necessary fluidic system and mechanics for conducted a plurality of measurements. Such example biological fluid analysers may further comprise a solution pack comprising one or more solutions, which the example biological fluid analyser may be configured to administer and release by use of its fluidic system and mechanics to automatically at least partially prepare the prepared body fluid sample after aspiration and may be configured to control the fluidic system to perform a cleaning program of at least the multi-use cuvette prior and/or post biological fluid analysis.

The prepared biological fluid sample may be a prepared blood sample may comprise a blood sample prepared with one or more reagents, chemicals, treatments, and/or processes. The prepared blood sample may for example comprise a blood sample which has been stained, such as chemically stained. The prepared blood sample may for example comprise a blood sample which has been hemolyzed, for example wherein most of the red blood cells in the blood sample have been removed. The prepared blood sample may for example comprise a blood sample which has been positioned/fixed, such that substantially no cell movement occurs while obtaining/acquiring the images of the prepared blood sample. The prepared blood sample may be understood as a solution comprising blood and one or more reagents and/or chemicals. The prepared blood sample may be understood as a dissolution, e.g. a dissolved blood sample. The prepared blood sample may be placed/positioned in a container, such as a cuvette, while the image data, e.g. the plurality of images of the prepared blood sample, is obtained/acquired. The height that the image planes are associated with may be a height or distance, e.g. on the z-axis, with respect to the bottom of the container/cuvette or with respect to the camera/microscope, when the image was obtained/captured. The image planes that the plurality of images may extend in a two-dimensional plane, e.g. a x-y-plane perpendicular with respect to the z-axis.

Optionally, the image data ID comprises first image data ID_1, such as image data comprising first image data ID_1 associated with a first image plane, also denoted IP_1. In other words, the image data may comprise first image data comprising one or more images being associated with a first image plane of the image stack. Optionally, the biological fluid analyser is configured to select an image, also denoted I_i, where i is the number of the selected image, associated with an image plane, also denoted IP_i, of the prepared biological fluid sample from the image data ID, such as from the image stack. The biological fluid analyser may be configured to select a first image, also denoted I_1, associated with a first image plane IP_1 of the prepared biological fluid sample from the image data ID. In other words, to select an image I_i may comprise to select a first image I_1 associated with a first image plane IP_1 of the prepared biological fluid sample from the image data ID. The first image I_1 may be selected from a plurality of images obtained from the image data ID. Optionally, the biological fluid analyser may be configured to select a second image I_2, a third image I_3, a fourth image I_4, and/or a fifth image I_5. In one or more exemplary biological fluid analysers, the biological fluid analyser may be configured to select more images, such as ten images, twenty images, or more. The images selected from the image data may be selected from a set of images, e.g., at least 20 images each associated with an image plane of the prepared biological fluid sample. To select image data may comprise to populate a data set with one or more images of the prepared biological fluid sample, e.g., to provide a stack of images. Each image of the stack of images may be associated with an image plane having a different associated height along a z-axis of the prepared biological fluid sample. In other words, each image plane may be associated with a different height along a z-axis of the prepared biological fluid sample.

To obtain first image data ID_1 comprises to obtain first primary image data ID_1_1 of the first image plane IP_1. The first primary image data ID_1_1 is associated with a first incident light setting ILS_1. Optionally, the first incident light setting ILS_1 may have a first angular light distribution ALD_1. In other words, the first primary image data ID_1_1 may be seen as obtained with and/or according to a first incident light setting ILS_1 having a first angular light distribution ALD_1. The first primary image data ID_1_1 may be associated with image data obtained from the prepared biological fluid sample while the prepared biological fluid sample has been illuminated with a probing light according to a first incident light setting ILS_1 having a first angular light distribution ALD_1.

A first incident light setting ILS_1 may comprise one or more microscope settings, one or more light source settings, and/or one or more aperture settings. A first incident light setting may provide a probing light probing the prepared biological fluid sample, such as incident on the prepared biological fluid sample. In other words, a first incident light setting ILS_1 may be provided via one or more of microscope settings, light source settings, and/or aperture settings.

In one or more exemplary biological fluid analysers, the first image plane is associated with a first height, also denoted H_1, in the prepared biological fluid sample. The first height that the first image plane is associated with may be a height, e.g., on the z-axis, with respect to the bottom of the container/cuvette or with respect to the camera/microscope, when the first image data, such as a first image, was obtained/captured.

To obtain first image data ID_1 comprises to obtain first secondary image data ID_1_2 of the first image plane IP_1. The first secondary image data ID_1_2 is associated with a second incident light setting ILS_2. Optionally, the second incident light setting ILS_2 may have a second angular light distribution ALD_2. In other words, the first secondary image data ID_1_2 may be seen as obtained with and/or according to a second incident light setting ILS_2 having a second angular light distribution ALD_2. The first secondary image data ID_1_2 may be associated with image data obtained from the prepared biological fluid sample while the prepared biological fluid sample has been illuminated with a probing light according to a second incident light setting ILS_2 having a second angular light distribution ALD_2.

A second incident light setting ILS_2 may comprise one or more microscope settings, one or more light source settings, and/or one or more aperture settings. A second incident light setting may provide a probing light probing the prepared biological fluid sample, such as incident on the prepared biological fluid sample. In other words, a second incident light setting ILS_2 may be provided via one or more of microscope settings, light source settings, and/or aperture settings.

An angular light distribution may be seen as a spatial distribution of light of an incident light. In other words, an angular light distribution may be seen as a spatial distribution of one or more light components incident on the prepared biological fluid sample. For example, an angular light distribution may be indicative of one or more light angles (such as spatial light angles) of a probing light probing the prepared biological fluid sample.

In one or more exemplary biological fluid analysers, to obtain first image data comprises to obtain first tertiary image data ID_1_3 of the first image plane IP_1. In one or more exemplary biological fluid analysers, the first tertiary image data ID_1_3 is associated with a third incident light setting ILS_3 having a third angular light distribution ALD_3. In one or more exemplary biological fluid analysers, to classify a cell in the prepared biological fluid sample is based on the first tertiary image data ID_1_3.

In other words, the first tertiary image data ID_1_3 may be seen as obtained with and/or according to a third incident light setting ILS_3 having a third angular light distribution ALD_3. The first tertiary image data ID_1_3 may be associated with image data obtained from the prepared biological fluid sample while the prepared biological fluid sample has been illuminated with a probing light according to a third incident light setting ILS_3 having a third angular light distribution ALD_3.

A third incident light setting ILS_3 may comprise one or more microscope settings, one or more light source settings, and/or one or more aperture settings. A third incident light setting may provide a probing light probing the prepared biological fluid sample, such as incident on the prepared biological fluid sample. In other words, a third incident light setting ILS_3 may be provided via one or more of microscope settings, light source settings, and/or aperture settings.

The description related to the first incident light setting ILS_1 and/or the second incident light setting ILS_2 may apply to the third incident light setting ILS_3.

In one or more exemplary biological fluid analysers, the first incident light setting comprises one or more of: lens assembly settings, aperture settings, an angle setting, and light source settings. In other words, the first incident light setting ILS_1 may comprise one or more of: first lens assembly settings, first aperture settings, a first angle setting, and first light source settings.

In one or more exemplary biological fluid analysers, the second incident light setting ILS_2 comprises one or more of: lens assembly settings, aperture settings, an angle setting, and light source settings. In other words, the second incident light setting ILS_2 may comprise one or more of: second lens assembly settings, second aperture settings, a second angle setting, and second light source settings.

Lens assembly settings may be seen as one or more settings associated with one or more lens assemblies, such as one or more of a first lens assembly, a second lens assembly, and a third lens assembly, which may be formed from one or more lenses. Lens assembly settings may be seen as the one or more lenses of a lens assembly may be arranged to direct the received light from a light source according to a desired light pattern. For example, a lens assembly may be configured to direct received light towards a rear focal point of the lens assembly. Lens assembly settings may comprise a configuration of a lens assembly to achieve a desired light pattern, such as the first incident light setting ILS_1 and/or the second incident light setting ILS_2. This may be achieved by a suitable combination of lenses, such as convex and concave lenses, having suitable indices of refraction.

Aperture settings may be seen as one or more settings associated with one or more aperture assemblies, such as one or more of a first aperture assembly, a second aperture assembly, and a third aperture assembly, which may be formed from one or more apertures. An aperture setting may comprise an aperture size, such as an aperture size of 2 mm, 3 mm, 4 mm, and/or 5 mm. An aperture size may be in the range of 1 mm to 10 mm. Aperture settings may be configured to provide the first incident light setting ILS_1 and/or the second incident light setting ILS_2. In other words, aperture settings may define a set of settings for one or more aperture assemblies, such as aperture assemblies of a microscope, such as to provide the first incident light setting ILS_1 and/or the second incident light setting ILS_2. Aperture settings may comprise a configuration of an aperture assembly to achieve a desired light pattern, such as the first incident light setting ILS_1 and/or the second incident light setting ILS_2.

Light source settings may be seen as one or more settings associated with one or more light sources, such as one or more incident light source assemblies. A light source assembly may be formed from a supporting element which supports a plurality of light sources, such as a plurality of LEDs. The light source assembly may comprise electrical circuitry to provide electric power to the plurality of light sources. A light source assembly may be configured to emit light according to one or more configurations, such as one or more light configurations. Light source settings may be configured to provide the first incident light setting ILS_1 and/or the second incident light setting ILS_2. In other words, light source settings may define a set of settings for one or more light source assemblies, such as light source assemblies of a microscope, such as to provide the first incident light setting ILS_1 and/or the second incident light setting ILS_2. Light source settings may comprise a configuration of a light source assembly to achieve a desired light pattern, such as the first incident light setting ILS_1 and/or the second incident light setting ILS_2. Light source settings, such as the first incident light setting ILS_1 and/or the second incident light setting ILS_2, may comprise pattern settings and/or intensity setting.

An angle setting may be seen as one or more settings associated with one or more angles, such as one or more incident light angles of a probing light. An angle setting may be indicative of an angle of incident light in the range of 0° to 90°. For example, certain cell features as cell size and/or cell shape may be observed at larger angles, such as larger apertures (such as larger numerical apertures). An angle setting may be provided via one or more of the lens assembly settings, the aperture settings, and the light source settings. An angle setting may be configured to provide the first incident light setting ILS_1 and/or the second incident light setting ILS_2, such as a first light angle LA_1 and/or a second light angle LA_2. In other words, an angle setting may define a set of settings for one or more lens assemblies, aperture assemblies, and/or light source assemblies such as to provide the first incident light setting ILS_1 and/or the second incident light setting ILS_2. An angle setting may comprise a configuration of one or more of the lens assembly settings, the aperture settings, and the light source settings to achieve a desired angle pattern, such as the first incident light setting ILS_1 and/or the second incident light setting ILS_2.

In one or more exemplary biological fluid analysers, the first incident light setting ILS_1 is configured to provide incident light also denoted first probing light comprising a first light component LC_1 with a first light angle LA_1 larger than a first angle A_1. The first light component LC_1 may comprise one or more light rays comprised in the first light angle LA_1. The first light component LC_1 may comprise a first light range. In other words, the first primary image data ID_1_1 may be associated with the first light component LC_1 and/or the first light angle LA_1. The first primary image data ID_1_1 may be obtained from the prepared biological fluid sample, such as the first image plane IP_1, being illuminated with first probing light and/or the first light component LC_1, such as with the first light angle LA_1. Larger than a first angle A_1 may be understood as the first light component LC_1 having a first light angle LA_1 of at least the first angle A_1. The first angle A_1 may be seen as a first incident light angle of the impinging light on the prepared biological fluid sample. The first angle A_1 may be in the range of 0° to 60°, such as the first light component being larger than the first angle A_1 in the range of 0° to 30°. The first angle A_1 may be measured with respect to the optical axis of the imaging device, e.g., an axis being perpendicular to the prepared biological fluid sample, such as measured around an axis being perpendicular to the prepared biological fluid sample.

First probing light provided according to the first incident light setting ILS_1 may comprise light having an incident light angle with regard to the optical axis of the imaging system less than a first upper light angle. The first upper light angle may be 15 degrees or less than 15 degrees, such as 15 degrees or less than 10 degrees or even 5 degrees or less than 5 degrees. In one or more example biological fluid analysers, first probing light provided according to the first incident light setting ILS_1 does not have light or substantially no light having an incident light angle with regard to the optical axis larger than the first upper light angle.

In one or more example biological fluid analysers, first probing light provided according to the first incident light setting ILS_1 may comprise light having an incident light angle with regard to the optical axis larger than a first lower light angle. The first lower light angle may be 0 degrees or larger than 0 degrees, such as 2 degrees or larger than 2 degrees, 5 degrees or larger than 5 degrees, or 10 degrees or larger than 10 degrees. In one or more example biological fluid analysers, first probing light provided according to the first incident light setting ILS_1 does not have light or substantially no light having an incident light angle with regard to the optical axis less than the first lower light angle.

The first lower light angle and the first upper light angle may define a first light angle range of the first probing light. The first light angle range may be from 0 degrees to 15 degrees, such as from 0 degrees to 10 degrees, e.g., from 5 to 10 degrees.

In other words, the imaging system may be configured to selectively provide first probing light comprising light with only incident light angle within the first light angle range.

In one or more exemplary biological fluid analysers, the second incident light setting ILS_2 is configured to provide incident light also denoted second probing light comprising a second light component LC_2 with a second light angle LA_2 larger than a second angle A_2. The second light component LC_2 may comprise one or more light rays comprised in the second light angle LA_2. The second light component LC_2 may comprise a second light range. In other words, the first secondary image data ID_1_2 may be associated with the second light component LC_2 and/or the second light angle LA_2. The first secondary image data ID_1_2 may be obtained from the prepared biological fluid sample, such as the second image plane IP_2, being illuminated with second probing light and/or the second light component LC_2, such as with the second light angle LA_2. Larger than a second angle A_2 may be understood as the second light component LC_2 having a second light angle LA_2 of at least the second angle A_2. The second angle A_2 may be seen as a second incident light angle of the impinging light on the prepared biological fluid sample. The second angle A_2 may be in the range of 10° to 90°, such as the second light component being larger than the second angle A_2 in the range of 15° to 90°. The second angle A_2 may be measured with respect to the optical axis of the imaging device, e.g., an axis being perpendicular to the prepared biological fluid sample, such as measured around an axis being perpendicular to the prepared biological fluid sample.

Second probing light provided according to the second incident light setting ILS_2 may comprise light having an incident light angle with regard to the optical axis of the imaging system less than a second upper light angle. The second upper light angle may be 30 degrees or less than 30 degrees, such as 20 degrees or less than 20 degrees or even 17 degrees or less than 17 degrees. In one or more example biological fluid analysers, second probing light provided according to the second incident light setting ILS_2 does not have light or substantially no light having an incident light angle with regard to the optical axis larger than the second upper light angle.

In one or more example biological fluid analysers, second probing light provided according to the second incident light setting ILS_2 may comprise light having an incident light angle with regard to the optical axis larger than a second lower light angle. The second lower light angle may be larger than the first upper light angle. The second lower light angle may be 0 degrees or larger than 0 degrees, such as 2 degrees or larger than 2 degrees, 5 degrees or larger than 5 degrees, or 10 degrees or larger than 10 degrees. In one or more example biological fluid analysers, second probing light provided according to the second incident light setting ILS_2 does not have light or substantially no light having an incident light angle with regard to the optical axis less than the second lower light angle.

The second lower light angle and the second upper light angle may define a second light angle range of the second probing light. The second light angle range may be from 0 degrees to 20 degrees, such as from 5 degrees to 20 degrees, e.g., from 10 to 17 degrees. The second light angle range and the first light angle range may be non-overlapping.

In other words, the imaging system may be configured to selectively provide second probing light comprising light with only incident light angle within the second light angle range.

In one or more exemplary biological fluid analysers, N incident light settings ILS_1, ILS, ILS_2, . . . , ILS_N may be applied to each image plane. The number N of incident light settings may be two, three, four, five, six, seven, or more. N may be in the range from 2 to 5.

In one or more exemplary biological fluid analysers, the first incident light setting ILS_1 comprises an aperture setting indicative of a first aperture size AS_1 used for obtaining the first primary image data. The first aperture size AS_1 may be of 2 mm, 3 mm, 4 mm, and/or 5 mm. The first aperture size AS_1 may be in the range of 1 mm to 10 mm. In other words, the first primary image data ID_1_1 may be obtained when using the first aperture size AS_1 for illuminating the prepared biological fluid sample. In other words, the first incident light setting ILS_1 may be obtained with a first aperture AP_1.

In one or more exemplary biological fluid analysers, the second incident light setting ILS_2 comprises an aperture setting indicative of a second aperture size AS_2 used for obtaining the second primary image data. The second aperture size AS_2 may be of 2 mm, 3 mm, 4 mm, and/or 5 mm. The second aperture size AS_2 may be in the range of 1 mm to 10 mm. In other words, the first secondary image data ID_1_2 may be obtained when using the second aperture size AS_1 for illuminating the prepared biological fluid sample. An aperture size may be seen as an opening size of an aperture assembly. In other words, the second incident light setting ILS_2 may be obtained with a second aperture AP_2.

In one or more exemplary biological fluid analysers, the second incident light setting ILS_2 is configured to provide incident light angles non-overlapping with incident light angles according to the first incident light setting ILS_1. In other words, the second incident light setting ILS_2 may be configured to provide incident light rays non-overlapping with incident light rays according to the first incident light setting ILS_1. For example, the first light component LC_1 may not overlap the second light component LC_2. In other words, the second incident light setting ILS_2 may be configured to provide a spatial distribution of light components non-overlapping with a spatial distribution of light components provided by the first incident light setting ILS_1.

In one or more exemplary biological fluid analysers, the first aperture size is different from the second aperture size. For example, the first aperture size may be 3 mm and the second aperture size may be 4 mm. In one or more exemplary biological fluid analysers, a shape of the first aperture AP_1 is different from a shape of the second aperture AP_2. The first aperture may have a first shape which is circular, oval, rectangular, squared, non-circular or any other suitable shape. The second aperture may have a second shape which is circular, oval, rectangular, squared, non-circular or any other suitable shape.

In one or more exemplary biological fluid analysers, the first incident light setting ILS_1 and/or the second incident light setting ILS_2 comprise an aperture setting indicative of a numerical aperture in the range from 0 to 0.7.

In one or more exemplary biological fluid analysers, the biological fluid analyser is configured to determine a set of cell regions, also denoted SCR_i, based on the image data ID. In one or more exemplary biological fluid analysers, the biological fluid analyser is configured to determine the set of cell regions, also denoted SCR, based on the first image data ID_1.

In one or more exemplary biological fluid analysers, to determine a set of cell regions SCR_i may comprise to characterize the image data, such as characterize one or more images I_i of the image stack. In one or more exemplary biological fluid analysers, to determine the set of cell regions SCR_i based on the image data comprises to determine a set of cell regions, also denoted SCR_i belonging to the image plane IP_i. A cell region, also denoted CR_k_i, k=1, 2, . . . . K, where K is the number of cell regions in the set of cell regions SCR_i and where i is the number of the selected image, may be understood as a group of pixels in the image I_i representing one or more cells, a part of a cell, parts of cells, or an optical phenomena relating to a cell or a plurality of cells. In other words, the set of cell regions SCR_i comprises one or more cell regions CR_k_i, e.g., one or more group of pixels in the image I_i representing one or more cells, one or more parts of one or more cells, or optical phenomena relating to one or more cells. A cell region may preferably represent a single cell, a part of a single cell, or an optical phenomenon relating to a single cell.

In one or more exemplary biological fluid analysers, to determine a set of cell regions SCR_i may comprise to characterize the first image I_1. In one or more exemplary biological fluid analysers, to determine the set of cell regions is based on the first image data ID_1. In one or more exemplary biological fluid analysers, to determine the set of cell regions SCR based on the image data comprises to determine a first set of cell regions SCR_1 belonging to the first image plane IP_1. In other words, to characterize the image I_i may comprise to characterize the first image I_1. In other words, to determine a set of cell regions SCR_i based on the image data, may comprise to determine a set of cell regions SCR_i belonging to the image plane IP_i. In other words, to determine a set of cell regions SCR_i belonging to the image plane IP_i may comprise to determine a first set of cell regions SCR_1 being in focus in or associated with the first image plane IP_1. Belonging to an image plane, such as being in focus, may be seen as where the cell regions CR_k_i (such as the cells) of the first set of cell regions SCR_1 are in best focus. In other words, the set of cell regions SCR_i, such as the first set of cell regions SCR_1, may comprise one or more cell regions, e.g., one or more groups of pixels in the first image I_1 representing one or more cells, one or more parts of one or more cells, or optical phenomena relating to one or more cells. In one or more exemplary biological fluid analysers, to determine a set of cell regions SCR_i may comprise to populate of data set with one or more cell regions CR_k_i associated with a group of pixels in the image I_i representing one or more cells, a part of a cell, parts of cells, or an optical phenomenon relating to a cell or a plurality of cells.

Belonging to the image plane IP_i, such as belonging to the first image plane IP_1, may be understood as cell regions CR_k_i representing cells (e.g. the volume of the cell) being located mostly in the image plane IP_i, at the time when the image was obtained/captured, or cell regions being assigned to or in focus in an image plane. For example, belonging to the image plane IP_i may be understood as cell regions CR_k_i representing cells being located mostly in the volume around the image plane IP_i, such as centred around the image plane IP_i. For example, belonging to the image plane IP_i may be understood as cell regions CR_k_i representing cells being located in the volume around the image plane IP_i. The distance between two image planes, such as a first distal distance also denoted DD_1 between the first image plane IP_1 and a first distal image plane DIP_1 on a distal side of the first image plane IP_1, and a first proximal distance also denoted PD_1 between the first image plane IP_1 and a first proximal image plane PIP_1 on a proximal side of the first image plane IP_1 may be in the range from 1 μm to 20 μm, such as in the range of 2 μm to 15 μm, such as in the range of 2 μm to 10 μm, such as in the range of 2 μm to 8 μm, in the range of 3 μm to 6 μm, in the range of 1 μm to 8 μm, and/or in the range of 1 μm to 6 μm. For example, when the cell of interest is platelets, e.g., since platelets have a diameter in the range of 1 μm to 5 μm, such as in the range of 2 μm to 3 μm. For example, a first distal distance DD_1 between the first image plane IP_1 and the first distal image plane DIP_1, and a first proximal distance also denoted PD_1 between the first image plane IP_1 and the first proximal image plane PIP_1 may for example be 3 μm, 3.5 μm, 4 μm, 4.5 μm, 5 μm, 5.5 μm, 6 μm, 7 μm, 8 μm, 9 μm, and/or 10 μm e.g. when the cell of interest is platelets, e.g., since platelets have a diameter in the range of 1 μm to 5 μm. For example, when the distance D between the image plane IP_i and the next neighbouring image plane is 5.04 μm, the belonging to the image plane IP_i may be understood as cell regions CR_k_i representing cells being located in the volume +2.02 μm and −2.02 μm around the image plane IP_i. Belonging to the image plane IP_i may be understood as cell regions CR_k_i representing cells being located in the volume between the image plane IP_i and the next neighbouring image plane, e.g., the next neighbouring distal image plane and/or the next neighbouring proximal image plane. In one or more exemplary biological fluid analysers, a set of cell regions may extend in more than one image plane. For example, when a cell region represents a cell larger than the distance between two image planes, the cell may extend to more than one image plane. In one or more exemplary biological fluid analysers, a set of cell regions may be assigned to an image plane, such as the first image plane IP_1. In one or more exemplary biological fluid analysers, the distance between two neighbouring image planes may be based on the size of a cell type of interest, e.g., to make sure that a cell belongs to an image plane. For example, a white blood cell having a diameter in the range e.g. of 5 μm to 10 μm may belong to two image planes.

The biological fluid analyser is configured to classify, based on the first primary image data ID_1_1 and/or the first secondary image data ID_1_2, a cell, also denoted CE in the prepared biological fluid sample. In other words, the biological fluid analyser may be configured to characterize a cell content of the prepared biological fluid sample, based on the first primary image data and/or the first secondary image data. For example, the biological fluid analyser may be configured to classify, based on the first primary image data ID_1_1 and/or the first secondary image data ID_1_2, each cell of the cell regions of the first image plane IP_1. In one or more exemplary biological fluid analysers, the biological fluid analyser may be configured to classify, based on the first primary image data ID_1_1 and/or the first secondary image data ID_1_2, a cell, such as a first cell CE_1, in a first cell region CR_k_1 of the set of cell regions SCR_i. To classify a first cell CE_1 in a first cell region CR_k_1 of the set of cell regions SCR_i may comprise to characterize a cell content of the prepared biological fluid sample based on the first primary image data and/or the first secondary image data ID_1_2.

In one or more exemplary biological fluid analysers, the biological fluid analyser is configured to classify each cell of the cell regions of the first image plane IP_1 based on the first primary image data ID_1_1 and/or the first secondary image data ID_1_2.

The biological fluid analyser is configured to determine classify, based on the first primary image data and/or the first secondary image data ID_1_2, a cell CE in the prepared biological fluid sample, for provision of a cell parameter, also denoted CP, associated with the cell CE.

In other words, the biological fluid analyser is configured to provide a cell parameter CP_k_i indicative of a cell type of the cell CE based on the classification of the cell CE. The biological fluid analyser may be configured to determine a cell parameter, also denoted CP_k_i, where i is the number of the selected image, such as image plane, and k is the number of the cell region, for each cell region CR_k_i of the set of cell regions SCR_i. To provide a cell parameter CP_k_i may comprise to classify a cell CE associated with or represented by a cell region CR_k_i based on the first primary image data ID_1_1 and/or the first secondary image data ID_1_2. The cell parameter CP_k_i may for example comprise cell type information. The cell parameter CP_k_i may for example comprise a cell type identifier indicative of a cell type of the cell. To provide a cell parameter CP_k_i may comprise to determine a cell parameter CP_k_i based on the classification. To provide a cell parameter CP_k_i may comprise to classify a cell CE associated with or represented by a cell region CR_k_i based on optical phenomena (such as optical phenomena of the cell in a neighbouring image plane and/or with a different incident light setting), such as optical phenomena detected in the first primary image data ID_1_1 and/or the first secondary image data ID_1_2. To provide a cell parameter CP_k_i may comprise to classify a cell CE associated with or represented by a cell region CR_k_i based on information determined from the first primary image data ID_1_1 and/or the first secondary image data ID_1_2.

The biological fluid analyser may be configured to determine classify, based on the first primary image data and/or the first secondary image data ID_1_2, a first cell CE_1 in a first cell region CR_1 of the set of cell regions SCR_i, for provision of a first cell parameter, also denoted CP_1, indicative of a cell type of the first cell CE_1. The cell parameter may comprise the first cell parameter. In other words, the biological fluid analyser is configured to provide a cell parameter CP_k_i indicative of a cell type of the first cell CE_1 based on the classification of the first cell CE_1. The biological fluid analyser may be configured to determine a first cell parameter, also denoted CP_k_i, where i is the number of the selected image and k is the number of the cell region, for each cell region CR_k_i of the set of cell regions SCR_i. To provide a cell parameter CP_k_i may comprise to classify a first cell CE_1_i associated with or represented by the first cell region CR_k_1 based on the first primary image data and/or the first secondary image data ID_1_2. The cell parameter CP_k_i may for example comprise cell type information. The cell parameter CP_k_i may for example comprise a cell type identifier indicative of a cell type of the first cell. To provide a cell parameter CP_k_i may comprise to determine a cell parameter CP_k_i based on the classification. To provide a cell parameter CP_k_i may comprise to classify a first cell CE_1_i associated with or represented by the first cell region CR_k_1 based on optical phenomena (such as optical phenomena of the cell in a neighbouring image plane and/or image data obtained with different incident light settings, such as the first primary image data obtained with the first incident light setting ILS_1 and/or the first secondary image data obtained with the second incident light setting ILS_2). An advantage of obtaining the first primary image data obtained with the first incident light setting ILS_1 and/or obtaining the first secondary image data obtained with the second incident light setting ILS_2 is that additional information about a cell may be obtained. For example, different optical phenomena may occur with different incident light settings. For example, a cell may act as a lens, such as a “lens effect” occurring, depending on the incident light setting (such as angle) of an illuminating light probing the prepared biological fluid sample. In other words, the combination of traditional cell features and “lens effect” may give more information about the cells than cell features alone, and therefore improves the classification, e.g., when using reduced magnification and/or moderate quality optics.

To provide a cell parameter CP_k_i may comprise to classify a first cell CE_1_i associated with or represented by the first cell region CR_k_1 based on information determined from the first primary image data and/or the first secondary image data ID_1_2.

In one or more exemplary biological fluid analysers, to classify the cell CE comprises to apply a classification model to one or more of: the first primary image data ID_1_1, the first secondary image data ID_1_2, and the first tertiary image data ID_1_3. In one or more exemplary biological fluid analysers, to classify the cell CE comprises to apply a classification model to one or more of: the first primary image data ID_1_1, the first secondary image data ID_1_2, the first tertiary image data ID_1_3, second primary image data ID_2_1, second secondary image data ID_2_2, and second tertiary image data ID_2_3.

In one or more exemplary biological fluid analysers, the biological fluid analyser/processor comprises classification circuitry configured to operate according to one or more classification models. In one or more exemplary biological fluid analysers, the provision of the cell parameter CP_k_i comprises to apply a classification model to one or more of: the first primary image data ID_1_1, the first secondary image data ID_1_2, and the first tertiary image data ID_1_3. To classify a cell in the prepared biological fluid sample, such as in a cell region, may comprise to determine whether the cell region and/or the cell satisfies one or more criteria, such as one or more features (e.g., cell feature), of the classification model. To classify a cell in the prepared biological fluid sample, such as in a cell region, may comprise to determine a cell type of the cell based on the classification model. The biological fluid analyser, such as using the classification circuitry, may be configured to extract one or more features, such as cell features, from the first primary image data, the first secondary image data, and/or the first tertiary image data. A cell feature may represent one or more cells, a part of a cell, parts of cells, or an optical phenomenon relating to a cell or a plurality of cells. The biological fluid analyser, such as using the classification circuitry, may be configured to extract one or more features from the cell region, such as for extract one or more features from a plurality of cell regions of the set of cell region SCR_i. The extracted features may be fed by the biological fluid analyser as input to the classification model, such as to the classification circuitry. An input to the classification model may for example comprise the first primary image data ID_1_1, the first secondary image data ID_1_2, and/or the first tertiary image data ID_1_3, comprising a cell information vector, such as a cell feature vector. The classification circuitry may comprise a neural network comprising one or a plurality of hidden layers. Each layer of the neural network may comprise one or more nodes. For example, the classification of the cell in the cell region may comprise to compare one or more features (such as cell features and/or optical features) present (such as extracted) in the first primary image data ID_1_1, the first secondary image data ID_1_2, and/or the first tertiary image data ID_1_3 with one or more model cells, such as cell regions, comprising cell features known to represent certain types of cells and/or optical phenoma. The classification model may be a neural network with an input layer, one or more hidden layers, such as a plurality of hidden layers, and an output layer. The input to the classification model may comprise a cell region (such as the cell region), a plurality of cell regions, and/or one or more population features. For example, an input to the classification model may comprise a cell region having a cell region size of 20*20 μm, e.g., comprising 412 pixels when having a pixel resolution of 0.5 μm. In one or more exemplary biological fluid analysers, the classification circuitry comprises a neural network for each cell type, such as cell class, the output layer of the neural network may therefore have one node. In one or more exemplary biological fluid analysers, the biological fluid analyser/processor comprises a neural network for all the cell types of interest. The output layer of the neural network may thereby have one node for each cell type or class. The output layer may be connected to the last hidden layer. The classification model may comprise an artificial neural network, ANN, such as a decision tree classifier. The classification model may be configured to detect and/or identify representative features, such as cell features. For example, the classification model may perform interference detection of features over a population of cells. The classification model may be configured to detect and/or identify representative features in scattergram flow cytometry scatter plots of the prepared biological fluid sample.

In one or more exemplary biological fluid analysers, the first image data ID_1 comprises first composite image data based on the first primary image data ID_1_1 and/or the first secondary image data_1_2, such as based on the first tertiary image data ID_1_3, second primary image data ID_2_1, second secondary image data ID_2_2, and second tertiary image data ID_2_3.

The biological fluid analyser may be configured to perform segmentation classification, such as using the classification model, based on the first composite image. For example, the biological fluid analyser may be configured to apply segmentation classification on one or more of the first primary image data ID_1_1, the first secondary image data ID_1_2, and the first tertiary image data ID_1_3. In other words, the biological fluid analyser may be configured to apply segmentation classification on image segments of one or more of the first primary image data ID_1_1, the first secondary image data ID_1_2, and the first tertiary image data ID_1_3.

The classification model may be or comprise any suitable machine learning model suitable for classification. For example, the classification model may implement at least one machine learning model, such as at least one multilayer perceptron (MLP), at least one convolutional neural network (CNN), at least one recurrent neural network (RNN), at least one autoencoder, at least one transformer, and/or the like.

In one or more example biological fluid analysers, the neural network may comprise a first hidden layer after the input layer. The input layer may be connected to the first hidden layer. The input layer may comprise as many nodes as the length, e.g., number of components, of the feature vector. The first hidden layer may comprise at least 3 nodes, such as at least 20 nodes. In one or more exemplary neural networks, the first hidden layer comprises in the range from 8 to 100 nodes, or in the range from 100 to 1,000 nodes, such as in the range from 200 to 500 nodes, e.g., about 300 nodes. In one or more exemplary neural networks, the neural network comprises a second hidden layer after the first hidden layer. The second hidden layer may comprise at least 5 nodes, such as at least 20 nodes. The second hidden layer optionally comprises in the range from 100 to 1,000 nodes, such as in the range from 8 to 100 nodes, or in the range from 200 to 500 nodes, e.g., about 300 nodes. In one or more exemplary neural networks, the neural network has less than 10 hidden layers, such as less than 5 hidden layers. The output/output layer of the neural network may comprise one or more output variables, such as at least 5 output variables. In one or more exemplary neural networks, the number of output variables is in the range from 6 to 15.

The biological fluid analyser (e.g., acting as a server) may be configured to train the classification model based on one or more of the first primary image data ID_1_1, the first secondary image data ID_1_2, and the first tertiary image data ID_1_3 (such as based on one or more population features).

In one or more exemplary biological fluid analysers, to classify a cell in the prepared biological fluid sample comprises to identify a cell type of the cell. In one or more exemplary biological fluid analysers, to classify the cell comprises to identify a cell (such as one or more cells) in the first cell region. In other words, to classify the cell comprises to identify one or more group of pixels representing a cell in a cell region. In other words, to classify the first cell comprises to identify one or more group of pixels in one or more of the first primary image data ID_1_1, the first secondary image data ID_1_2, and the first tertiary image data ID_1_3, representing a cell.

A cell type as disclosed herein may for example be seen as a white blood cell, WBCs, a platelet, PLT, a red blood cell, RBCs, a clot of blood components, a cell debris, and/or an external particle, e.g., dust, precipitation, or residues from the container or the like. A cell type as disclosed herein may for example be seen as a mature cell such as a Reticulocyte, a Lymphocyte, a Monocyte, segmented and band-shaped Granulocyte: Neutrophil, Eosinophil, and/or Basophil, and/or an immature cell such as a Normoblast, an Erythroblast, a Proerythroblast, a Metamyelocyte, a Myelocyte, a Promyelocyte, a Myeloblast, a Monoblast, and/or a Lymphoblast.

In one or more exemplary biological fluid analysers, to classify a cell comprises to determine a cell feature associated with the cell, such as associated with the cell region comprising the cell. In one or more exemplary biological fluid analysers, to classify the cell comprises to determine a cell feature associated with the cell region based on the first primary image data ID_1_1 and/or the first secondary image data ID_1_2. In other words, to classify the cell comprises to determine a cell feature associated with the cell. To classify the cell may comprise to determine a plurality of cell features associated with the cell region, such as comprising a first cell feature, a second cell feature etc. A cell feature may comprise one or more of: a lobe feature, an area feature, a contrast feature, a roundness feature, a granularity feature, a nucleus feature, an optical feature, a cytoplasm feature, a membrane feature, a morphology feature, and a function of one or more of the previous features. In one or more exemplary biological fluid analysers, the biological fluid analyser is configured to classify the cell based on the determination of the cell feature being one or more of the lobe feature, the area feature, the contrast feature, the roundness feature, the granularity feature, the nucleus feature, the optical feature, the cytoplasm feature, the membrane feature, the morphology feature, and the function of one or more of the previous features. A cell parameter, such as the first cell parameter, may be determined based on one or more cell features.

In one or more exemplary biological fluid analysers, to provide a cell parameter of the first cell comprises to determine, based on the first primary image data ID_1_1 and/or the first secondary image data ID_1_2, a cell parameter for a plurality of cell regions of the set of cell regions for providing a plurality of cell parameters. To provide a cell parameter of the first cell may comprise to determine, based on the first primary image data ID_1_1 and/or the first secondary image data ID_1_2, a cell parameter for a plurality of cell regions of the set of cell regions for providing a plurality of cell parameters. In other words, the biological fluid analyser may be configured to determine a cell parameter for each of the cell regions of the set of cell regions.

In one or more exemplary biological fluid analysers, the biological fluid analyser is configured to determine, based on the cell parameter, a cell representation of the prepared biological fluid sample. In one or more exemplary biological fluid analysers, the biological fluid analyser is configured to determine a cell representation of the prepared biological fluid sample based on the plurality of cell parameters. To determine a cell representation of the prepared biological fluid sample may comprise to determine a cell representation of an image plane, such as the first image plane, and/or a cell representation of the image data. A cell representation may be seen as a biological fluid parameter of the prepared biological fluid sample. To determine a cell representation of the prepared biological fluid sample may comprise to determine a number of cell regions comprising the same or similar cell parameter, cell feature, and/or cell type, such as determining one or more cell counts, e.g., a white blood cell count and/or a platelet count. To determine a cell representation of the prepared biological fluid sample may comprise to determine a number of cell regions having the same or similar cell parameter, such as cell parameter. A cell representation may comprise one or more cell concentrations, such as a white blood cell concentration and/or a platelet concentration. A cell representation may comprise a white blood cell count or white blood cell concentration of different types of white blood cells, such as a count or concentration of Basophil, Eosinophil, Lymphocyte, Monocyte, Neutrophil, and/or plastic beads. The first blood parameter may comprise a 3-part WBC DIFF and/or a 5-part WBC DIFF. To determine a cell representation may comprise to count the number of cell regions CR_k_i in one or more image planes IP_i, having the same or similar cell parameter and/or cell feature.

In one or more exemplary biological fluid analysers, the provision of the cell parameter is based on a cell feature indicative of one or more of: a lobe feature, an area feature, a contrast feature, a roundness feature, a granularity feature, a nucleus feature, an optical feature, and a function of one or more of the previous features. In one or more exemplary biological fluid analysers, the cell feature comprises a membrane feature, a geometry feature, a morphology feature, and/or a cell classification and/or type feature. A membrane feature may for example be indicative of information on a shape and/or texture of a cell membrane.

A lobe feature may be seen as a feature indicative of information on one or more lobes of a cell, such as the cell. For example, a lobe feature may comprise information regarding a lobe configuration of a cell. A lobe feature may be indicative of a segmentation of a cell, such as a segmentation in blobs and/or lobes of a cell. A lobe feature may be indicative of one or more of: a number of nucleus lobes of a cell, a size of one or more lobes of a cell, a position of one or more lobes of a cell, and/or a size ratio between one or more lobes of a cell and the cell. A lobe feature comprised in the cell feature may be seen as a lobe cell feature. For example, a lobe feature may be seen as a feature indicative of information on one or more lobes of a plurality of cells of the prepared biological fluid sample. A lobe feature may for example be indicative of the cell comprising one, two, or three lobes.

An area feature may be seen as a feature indicative of information on an area of a cell, such as of the cell. For example, an area feature may comprise information regarding an area size of a cell. An area feature may be indicative of one or more of: a pixel size, a pixel area, an area of a cell, an area of a lobe, and an area of a nucleus. An area feature comprised in the cell feature may be seen as an area cell feature. For example, an area feature may be seen as a feature indicative of information on an area of a plurality of cells of the prepared biological fluid sample. An area of a cell may be in the range of 10 μm² to 350 μm².

A contrast feature may be seen as a feature indicative of information on a contrast of a cell, such as of the cell. For example, a contrast feature may comprise information regarding a contrast value of a cell. A contrast feature may be indicative of one or more of: a mean pixel intensity of a nucleus and/or a cytoplasm, and a color parameter. A contrast feature comprised in the cell feature may be seen as a contrast cell feature. For example, a contrast feature may be seen as a feature indicative of information on a contrast of a plurality of cells of the prepared biological fluid sample. A contrast feature may be seen as a difference in light intensity between an image (such as in a cell region) and an adjacent background relative to an overall background intensity. A contrast of a cell may be in the range of 10% to 90%, such as 50%.

A roundness feature may be seen as a feature indicative of information on a roundness and/or a circularity of a cell, such as of the cell. For example, a roundness feature may comprise information regarding a roundness value and/or a circularity value of a cell. A roundness feature comprised in the cell feature may be seen as a roundness cell feature. For example, a roundness feature may be seen as a feature indicative of information on a roundness of a plurality of cells of the prepared biological fluid sample. A roundness parameter may be determined with the following formula: 4*Area(A)*Pi(π)/(divided by) Perimeter\hat{ }2 (P²). A roundness parameter may be in the range of 0 to 1, where 1 is the circularity of a perfect circular disk. For example, when a cell region satisfies a roundness criterion, such as the cell region is above a roundness threshold and/or when the cell region is in a roundness range, the cell region may be characterized as a platelet. A roundness threshold may for example be 0.8 when detecting, identifying, classifying, and/or characterizing platelets.

A granularity feature may be seen as a feature indicative of information on a granularity and/or a complexity of a cell, such as of the cell. For example, a granularity feature may comprise information regarding a granularity value of a cell. A granularity feature may be indicative of one or more of: a side scatter measurement information, an internal complexity of a cell, and a cell type. A granularity feature comprised in the cell feature may be seen as a granularity cell feature. For example, a granularity feature may be seen as a feature indicative of information on a granularity of a plurality of cells of the prepared biological fluid sample.

A nucleus feature may be seen as a feature indicative of information on a nucleus of a cell, such as of the cell. For example, a nucleus feature may comprise information regarding a nucleus size and/or type of a cell. A nucleus feature may be indicative of an area of a nucleus. A nucleus feature comprised in the cell feature may be seen as a nucleus cell feature. For example, a nucleus feature may be seen as a feature indicative of information on a nucleus of a plurality of cells of the prepared biological fluid sample. An area of a nucleus of a cell may be in the range of 0.1 μm to 5 μm, such as in the range from 0.5 μm to 2 μm.

An optical feature may be seen as a feature indicative of information on an optical phenomenon of a cell, such as an optical phenomenon in the cell region comprising the cell. For example, an optical feature may comprise information regarding a bright spot, such as bright spot detection, and/or a dark spot, such as dark spot detection. An optical feature comprised in the cell feature may be seen as an optical cell feature. For example, an optical feature may be seen as a feature indicative of information on an optical phenomenon of a plurality of cells of the prepared biological fluid sample.

A cell feature may be a function of different features, such as derived from one or more of a lobe feature, an area feature, a contrast feature, a roundness feature, a granularity feature, an optical feature, and a nucleus feature.

In one or more exemplary biological fluid analysers, the biological fluid analyser is configured to classify the cell based on one or more of the lobe feature, the area feature, the contrast feature, the roundness feature, the granularity feature, the nucleus feature, the optical feature, and the function of one or more of the previous features. In other words, the biological fluid analyser may be configured to determine a cell type of the cell based on one or more of the lobe feature, the area feature, the contrast feature, the roundness feature, the granularity feature, the nucleus feature, and the function of one or more of the previous features.

In one or more exemplary biological fluid analysers, to classify the first cell comprises to determine an intermediate parameter, such as an intermediate representation, using an auto-encoder. In other words, the classification model may comprise one or more intermediate layers for providing one or more intermediate parameters of the cell, such as using an auto-encoder.

In one or more exemplary biological fluid analysers, to obtain image data comprises to obtain second image data ID_2 associated with a second image plane IP_2. In one or more exemplary biological fluid analysers, to obtain second image data ID_2 comprises one or more of to: obtain second primary image data ID_2_1 of a second image plane IP_2 in the prepared biological fluid sample, the second primary image data ID_2_1 associated with the first incident light setting ILS_1, and obtain second secondary image data ID_2_2 of the second image plane IP_2 of the prepared biological fluid sample, the second secondary image data ID_2_2 associated with the second incident light setting ILS_2. In one or more exemplary biological fluid analysers, to obtain second image data ID_2 comprises to obtain second tertiary image data ID_2_3 of a second image plane IP_2 in the prepared biological fluid sample, the second tertiary image data ID_2_3 associated with the third incident light setting ILS_3.

In one or more exemplary biological fluid analysers, the second image plane is associated with a second height, also denoted H_2, in the prepared biological fluid sample. The second height that the second image plane is associated with may be a height, e.g., on the z-axis, with respect to the bottom of the container/cuvette or with respect to the camera/microscope, when the second primary image data and/or the second secondary image data, such as the second image, was obtained/captured. The second height H_2 may be different from the first height H_1.

In one or more exemplary biological fluid analysers, the biological fluid analyser is configured to classify, based on one or more of the second primary image data ID_2_1 and the second secondary image data ID_2_2, a cell in the prepared biological fluid sample.

In one or more exemplary biological fluid analysers, the biological fluid analyser is configured to classify, based on one or more of: the first primary image data ID_1_1, the first secondary image data ID_1_2, the first tertiary image data ID_1_3, the second primary image data ID_2_1, the second secondary image data ID_2_2, and the second tertiary image data ID_2_3, a cell in the prepared biological fluid sample.

In one or more exemplary biological fluid analysers, the biological fluid analyser is configured to classify, based on the second primary image data ID_2_1 and the first primary image data ID_1_2, a cell in the prepared biological fluid sample.

In one or more exemplary biological fluid analysers, to determine the set of cell regions SCR_i is based on the second image data ID_2, such as based on one or more of the second primary image data ID_2_1 and the second secondary image data ID_2_2.

A computer program product comprising a non-transitory computer readable medium, having thereon a computer program comprising program instructions is disclosed. The computer program is loadable into a data processing unit and configured to cause execution of the operations according to any of the biological fluid analysers as disclosed herein when the computer program is run by the data processing unit.

Also disclosed is a method for classifying a cell in a prepared biological fluid sample. The method may be performed by a biological fluid analyser as disclosed herein. The method comprises obtaining image data of one or more images planes in an image stack in the prepared biological fluid sample, the image data comprising first image data. Obtaining the first primary image data comprises obtaining first primary image data of the first image plane. The first primary image data is associated with a first incident light setting having a first angular light distribution. Obtaining the first primary image data comprises obtaining first secondary image data of the first image plane. The first secondary image data is associated with a second incident light setting having a second angular light distribution. The method comprises classifying, based on the first primary image data and the first secondary image data, a cell in the prepared biological fluid sample. The method comprises providing, based on the classification of the cell, a cell parameter associated with the cell.

It is to be understood that a description of a feature in relation to method(s) is also applicable to the corresponding feature in biological fluid analyser and/or system and vice-versa.

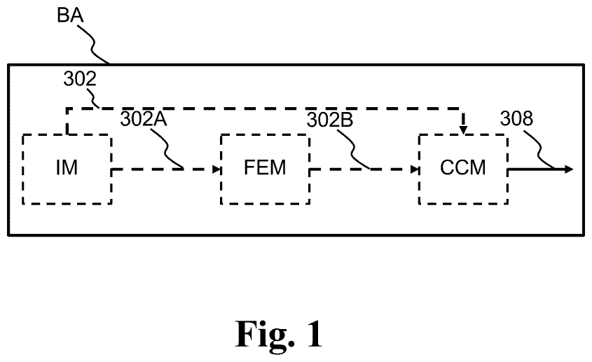

FIG. 1 schematically illustrates an exemplary biological fluid analyser BA, comprising a memory, an interface, and one or more processors. The biological fluid analyser BA is configured to obtain, such as using an image module IM, image data ID of one or more images planes of an image stack of a prepared biological fluid sample, the image data ID comprising first image data ID_1 associated with a first image plane IP_1. The biological fluid analyser BA is configured to obtain, such as using an image module IM, first primary image data ID_1_1 of the first image plane IP_1. The biological fluid analyser BA is configured to obtain, such as using an image module IM, first secondary image data ID_1_2 of the first image plane IP_1. The biological fluid analyser BA may be configured to determine, such as using the image module IM, a set of cell regions SCR_i based on the image data ID. Optionally, the biological fluid analyser may be configured to transmit 302A the image data, such as the first image data ID_1 (such as the first primary image data and/or the first secondary image data) and/or the set of cell regions SCR_i, e.g., comprised in a data set, from the image module IM to a feature extractor module FEM. The feature extractor module FEM, may be configured to extract one or more features from the image data ID, such as the first image data ID_1 and/or the set of cell regions SCR_i. For example, the feature extractor module FEM, may be configured to extract one or more cell features from the image data ID, such as the first image data ID_1 and/or the set of cell regions SCR_i. For example, the feature extractor module FEM, may be configured to extract one or more cell features from the first primary image data and/or the first secondary image data. Optionally, the biological fluid analyser may be configured to transmit 302B the extracted one or more features from the feature extractor module FEM to a classification circuitry module CCM.

Optionally, the biological fluid analyser may be configured to transmit 302 the image data ID, such as the first image data ID_1 and/or the set of cell regions SCR_i comprised in a data set, directly to the classification circuitry module CCM.

The biological fluid analyser BA is configured to classify, such as using the classification circuitry module CCM, based on the first primary image data ID_1 and the first secondary image data ID_1_2, a cell in the prepared biological fluid sample, for provision 308 of a cell parameter associated with the cell. In other words, the biological fluid analyser BA, such as using the classification circuitry module CCM, may be configured to output 308 a cell parameter associated with the cell, e.g., to a user, a database, and/or a server device.

In one or more exemplary biological fluid analysers, to obtain first image data comprises to obtain, such as using the image module IM, first tertiary image data ID_1_3 of the first image plane IP_1. In one or more exemplary biological fluid analysers, the first tertiary image data ID_1_3 is associated with a third incident light setting ILS_3 having a third angular light distribution ALD_3. In one or more exemplary biological fluid analysers, to classify a cell in the prepared biological fluid sample is based on the first tertiary image data ID_1_3.

In one or more exemplary biological fluid analysers, to determine a set of cell regions SCR_i based on the image data ID comprises to determine a first set of cell regions SCR_1 belonging to a first image plane IP_1.

In one or more exemplary biological fluid analysers, the biological fluid analyser may be configured to classify, such as using the classification circuitry module CCM, based on the first primary image data ID_1_1 and/or the first secondary image data ID_1_2, a cell, such as a first cell CE_1.

In one or more exemplary biological fluid analysers, to classify the cell CE comprises to apply, such as using the classification circuitry module CCM, a classification model to one or more of: the first primary image data ID_1_1, the first secondary image data ID_1_2, and the first tertiary image data ID_1_3. In one or more exemplary biological fluid analysers, to classify the cell CE comprises to apply, such as using the classification circuitry module CCM, a classification model to one or more of: the first primary image data ID_1_1, the first secondary image data ID_1_2, the first tertiary image data ID_1_3, second primary image data ID_2_1, second secondary image data ID_2_2, and second tertiary image data ID_2_3.

In one or more exemplary biological fluid analysers, to classify a cell in the prepared biological fluid sample comprises to identify, such as using the classification circuitry module CCM, a cell type of the cell.

In one or more exemplary biological fluid analysers, to obtain image data comprises to obtain, such as using the image module IM, second image data ID_2 associated with a second image plane IP_2.

In one or more exemplary biological fluid analysers, to obtain second image data ID_2 comprises one or more of to: obtain, such as using the image module IM, second primary image data ID_2_1 of a second image plane IP_2 in the prepared biological fluid sample, the second primary image data ID_2_1 associated with the first incident light setting ILS_1, and obtain, such as using the image module IM, second secondary image data ID_2_2 of the second image plane IP_2 of the prepared biological fluid sample, the second secondary image data ID_2_2 associated with the second incident light setting ILS_2. In one or more exemplary biological fluid analysers, to obtain second image data ID_2 comprises to obtain, such as using the image module IM, second tertiary image data ID_2_3 of a second image plane IP_2 in the prepared biological fluid sample, the second tertiary image data ID_2_3 associated with the third incident light setting ILS_3.

In one or more exemplary biological fluid analysers, the biological fluid analyser is configured to classify, such as using the classification circuitry module CCM, based on one or more of the second primary image data ID_2_1 and the second secondary image data ID_2_2, a cell in the prepared biological fluid sample.

In one or more exemplary biological fluid analysers, to determine the set of cell regions SCR_i is based on the second image data ID_2, such as based on one or more of the second primary image data ID_2_1 and the second secondary image data ID_2_2.

In one or more exemplary biological fluid analysers, to provide a cell parameter of the first cell comprises to determine, such as using the classification circuitry module CCM, based on the first primary image data ID_1_1 and/or the first secondary image data ID_1_2, a cell parameter for a plurality of cell regions of the set of cell regions for providing a plurality of cell parameters.

In one or more exemplary biological fluid analysers, the biological fluid analyser is configured to determine, such as using the classification circuitry module CCM, based on the cell parameter, a cell representation of the prepared biological fluid sample. In one or more exemplary biological fluid analysers, the biological fluid analyser BA may be configured to output 308, such as using the classification circuitry module CCM, the cell representation, e.g., to a user, a database, and/or a server device.

In one or more exemplary biological fluid analysers, the provision of the cell parameter is based on a cell feature indicative of one or more of: a lobe feature, an area feature, a contrast feature, a roundness feature, a granularity feature, a nucleus feature, an optical feature, and a function of one or more of the previous features.

In one or more exemplary biological fluid analysers, the first image data ID_1 comprises first composite image data based on the first primary image data ID_1_1 and/or the first secondary image data_1_2, such as based on the first tertiary image data ID_1_3, second primary image data ID_2_1, second secondary image data ID_2_2, and second tertiary image data ID_2_3.

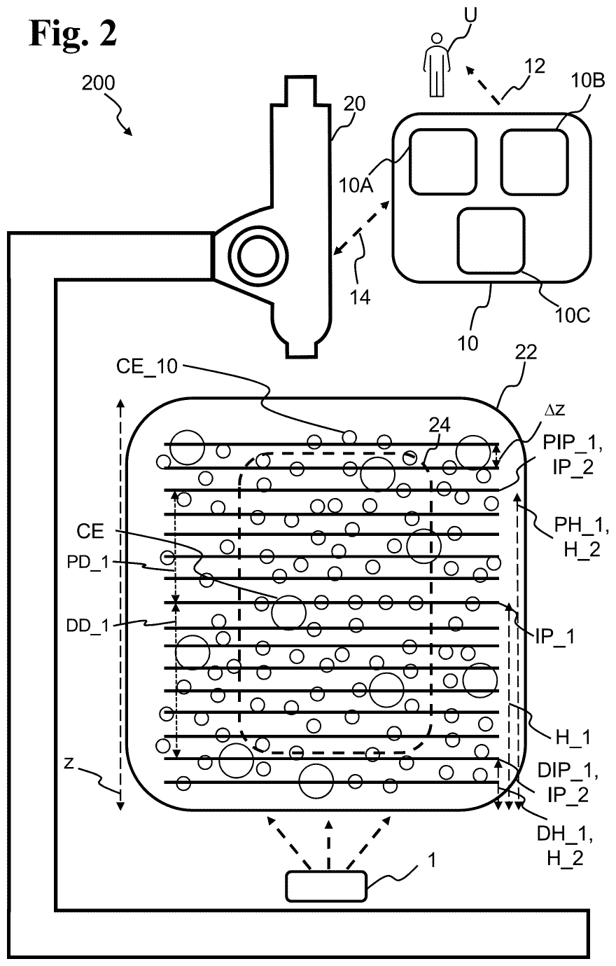

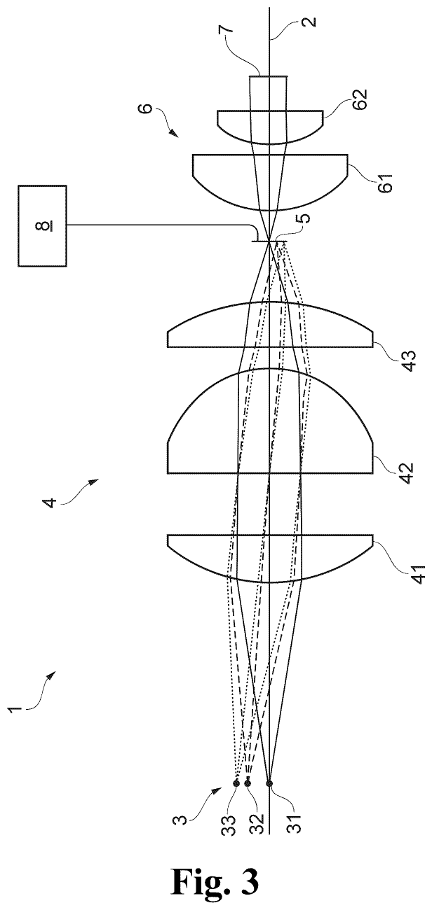

FIG. 2 schematically illustrates an exemplary system 200, comprising a microscope 20, an image acquiring device (not shown, e.g., implemented/integrated with the microscope), a prepared biological fluid sample in a container 22 (e.g. cuvette, cavity), an exemplary imaging system 1 (such as the imaging system 1 of FIG. 3), and a biological fluid analyser 10. Optionally, the system 200 comprises (such as comprises in the imaging system 1) an aperture device configured to apply an aperture to allow light from the first lens assembly to pass through the aperture in order to indirectly define a probing light.

The biological fluid analyser 10 is an example biological fluid analyser according to the disclosure. The biological fluid analyser 10 comprises a memory 10A, an interface 10B, and one or more processors, such as a processor 10C. The biological fluid analyser 10 is configured to obtain 14 image data ID of one or more images planes of an image stack in a prepared biological fluid sample, such as via the interface 10B from the image acquiring device. The image data ID comprises first image data ID_1 associated with a first image plane IP_1. Optionally, the biological fluid analyser 10 may be configured to obtain the image data from a network such as a global network, e.g., the internet or a telecommunications network. Optionally, the biological fluid analyser 10 may be configured to transmit 14 information (such as a cell parameter and/or a cell representation) to the microscope 20. For example, the biological fluid analyser 10 may be configured to obtain the image data from a server device (not shown), via the network. The prepared biological fluid sample may be placed/positioned in a container 22, such as a cuvette, while the image data ID, e.g., the plurality of images of the prepared biological fluid sample, is obtained/acquired, such as the first image I_1. The height that the image planes are associated with may be a height, e.g., on the z-axis, with respect to the bottom of the container 22 when the image was obtained/captured. The first image data may be associated with a first image plane IP_1 which may be associated with a first height H_1 in the prepared biological fluid sample. The image planes that the plurality of images may extend in a two dimensional plane, e.g., a x-y-plane with respect to the z-axis. The image data ID may therefore comprise a plurality of images being associated with images planes, where each image plane is separated by a distance Δz to the next obtained/acquired image plane and/or the previous obtained/acquired image plane. Δz may be the stepping incrimination for each obtained/acquired image. In the example of FIG. 2, sixteen image planes are represented including the first image plane IP_1, the first distal image plane DIP_1, and the first proximal image pane PIP_1. The number of images and image planes may be increased to comprise for example at least thirty, at least forty, or at least a hundred. The image data ID may comprise a plurality of images of the prepared biological fluid sample, where each image may be associated with an image plane being equidistant from the next obtained/acquired image plane and/or the previous obtained/acquired image plane. In other words, the image data ID may comprise a 3D image stack, such as a stack of images where each image of the image stack is associated with an image plane having a different associated height along the z-axis of the prepared biological fluid sample. The image data ID may comprise a plurality of images of a central portion 24 of the biological fluid sample. In other words, the image data ID may comprise a plurality of obtained/acquired images of the prepared biological fluid sample representing areas or volumes of the prepared biological fluid sample being located away from the edges of the container 22 in which the prepared biological fluid sample is contained. Alternatively or additionally, the image data ID may comprise a plurality of obtained/acquired images of the prepared biological fluid sample representing areas or volumes of the whole container 22, such as the full width and/or height of the container 22, e.g., including the windows of the container 22. The biological fluid sample may comprise a plurality of cells, such as a cell CE. For illustrative purposes the container 22 and the cells have been enlarged and are therefore not to scale. In the example shown in FIG. 2, the cell CE represent a white blood cell, WBC. The smaller cells, such as cell CE_10, may for example be platelets.

Each image of the image data ID may comprise a plurality of representations. The plurality of representations may comprise a plurality of particles, such as cells, e.g., white blood cells, WBCs, platelets, red blood cells, RBCs, and/or external particles, e.g., dust or residues from the container or the like. To obtain 14 the first image data ID_1 comprises to obtain 14 first primary image data ID_1_1 of the first image plane IP_1. The first primary image data ID_1_1 is associated with a first incident light setting ILS_1. The first incident light setting ILS_1 may optionally have a first angular light distribution. To obtain 14 the first image data ID_1 comprises to obtain 14 first secondary image data ID_1_2 of the first image plane IP_1. The first secondary image data ID_1_2 is associated with a second incident light setting ILS_2. The second incident light setting ILS_2 may optionally have a second angular light distribution.

The biological fluid analyser 10 is configured to classify, such as using the processor 10C, based on the first primary image data ID_1_1 and/or the first secondary image data ID_1_2, a cell in the prepared biological fluid sample for provision of a cell parameter CP associated with the cell. In one or more exemplary systems and/or biological fluid analysers, the biological fluid analyser 10 is configured to output 12, such as using the processor 10C and/or via the interface 10B, the cell parameter CP and/or a cell representation, e.g., to a user U, a database, and/or a server device.

In one or more exemplary biological fluid analysers, to obtain image data comprises to obtain second image data ID_2 associated with a second image plane IP_2.

In one or more exemplary biological fluid analysers, to obtain second image data ID_2 comprises one or more of to: obtain second primary image data ID_2_1 of a second image plane IP_2 in the prepared biological fluid sample, the second primary image data ID_2_1 associated with the first incident light setting ILS_1, and obtain second secondary image data ID_2_2 of the second image plane IP_2 of the prepared biological fluid sample, the second secondary image data ID_2_2 associated with the second incident light setting ILS_2. In one or more exemplary biological fluid analysers, to obtain second image data ID_2 comprises to obtain second tertiary image data ID_2_3 of a second image plane IP_2 in the prepared biological fluid sample, the second tertiary image data ID_2_3 associated with the third incident light setting ILS_3. The second image plane IP_2 may for example be a proximal image plane PIP, such as the first proximal image plane, and/or a distal image plane DIP, such as the first distal image plane DIP_1. In one or more exemplary biological fluid analysers, the second image plane IP_2 is associated with a second height, also denoted H_2, in the prepared biological fluid sample. The second height H_2 that the second image plane IP_2 is associated with may be a height, e.g., on the z-axis, with respect to the bottom of the container/cuvette or with respect to the camera/microscope, when the second primary image data and/or the second secondary image data, such as the second image, was obtained/captured. The second height H_2 may be different from the first height H_1.

In one or more exemplary biological fluid analysers, the biological fluid analyser is configured to classify, such as using the processor 10C, based on one or more of the second primary image data ID_2_1 and the second secondary image data ID_2_2, a cell in the prepared biological fluid sample.

In one or more exemplary systems and/or biological fluid analysers, the first proximal image plane PIP_1 is associated with a first proximal height PH_1 in the prepared biological fluid sample, the first proximal height PH_1 being different from the first height H_1.

A first distal distance also denoted DD_1 between the first image plane IP_1 and the first distal image plane DIP_1, and a first proximal distance also denoted PD_1 between the first image plane IP_1 and the first proximal image plane PIP_1 are in the range from 1 μm to 75 μm. In FIG. 2, the first distal distance DD_1 is larger than the first proximal distance PD_1.

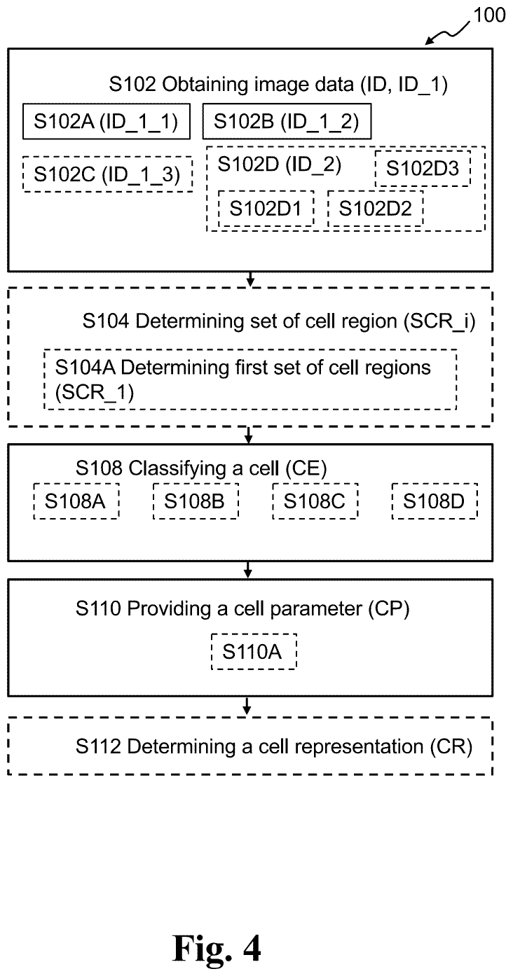

The biological fluid analyser 10 may be configured to perform any of the methods disclosed in FIG. 4.

The biological fluid analyser 10, such as the processor 10C, is optionally configured to perform any of the operations disclosed in FIG. 4 (such as any one or more of S102C, S102D, S102D1, S102D2, S102D3, S104A, S108A, S108B, S108C, S108D, S110A, S112). The operations of the biological fluid analyser may be embodied in the form of executable logic routines (for example, lines of code, software programs, etc.) that are stored on a non-transitory computer readable medium (for example, memory 10A) and are executed by the processor 10C.

Furthermore, the operations of the biological fluid analyser 10 may be considered a method that the biological fluid analyser 10 is configured to carry out. Also, while the described functions and operations may be implemented in software, such functionality may as well be carried out via dedicated hardware or firmware, or some combination of hardware, firmware and/or software.

FIG. 3 illustrates an exemplary imaging system 1. The imaging system 1 may be an example of an imaging system used to obtain image data, such as first image data ID_1, e.g., first primary image data ID_1_1, first secondary image data ID_1_2, first tertiary image data ID_1_3, second primary image data ID_2_1, second secondary image data ID_2_2, and/or second tertiary image data ID_2_3 as disclosed herein. The imaging system 1 comprises a light source assembly 3 and a first lens assembly 4. An optical axis 2 of the imaging system 1 extends across the light source assembly 3 and the first lens assembly 4. In the embodiment of FIG. 3, the first lens assembly 4 comprises a first lens 41, a second lens 42 and an optional third lens 43. The lenses 41, 42, 43 are configured to direct light emitted by the light source assembly 3 towards converging points downstream of the first lens assembly 4.

The system 1 of FIG. 3 may comprise an aperture device 5 configured to apply an aperture to allow light from the first lens assembly 4 to pass through the aperture. In the example biological fluid analyser of FIG. 3, the aperture device 5 extends along a rear focal plane of the first lens assembly 4. The converging points of the light directed by the first lens assembly 4 are located on the rear focal plane of the first lens assembly 4. Therefore, the applied aperture may be selectively applied to comprise one or more of the converging points.

In the embodiment of FIG. 3, the light source assembly comprises one or more of a first light source 31, a second light source 32 and a third light source 33. The first light source 31 is disposed on the optical axis 2 of the imaging system 1. The beams of light emitted by each of the light sources 31, 32, 33 converge at converging points on the rear focal plane of the first lens assembly 4. In the configuration of FIG. 3, the applied aperture in aperture device allows the light emitted by the three light sources 31, 32, 33 to pass through the applied aperture.

Downstream of the aperture device 5, the imaging device 1 of the system 1 of FIG. 3 comprises a second lens assembly 6. In system 1, the second lens assembly comprises a first lens 62 and/or a second lens 62. The second lens assembly 6 is configured to direct the light passing through the applied aperture in aperture device 5 and to focus the light on a rear focal plane of the second lens assembly 6. FIG. 3 shows that each converging point on the rear focal plane of the first lens assembly 4 gives rise to a different incidence angle on the rear focal plane of the second lens assembly 6. Therefore, the incidence angle of the light directed by the second lens assembly 6 on the rear focal plane of the second lens assembly 6 may be customised by the application of the aperture of the aperture device 5.

In the embodiment of FIG. 3, a probing volume 7 is defined along the rear focal plane of the second lens assembly 6. The probing volume 7 of FIG. 3 receives light having three different incidence angles. The light received by the probing volume 7 is referred to as probing light. Since the light passing through the applied aperture is directed by the second lens assembly 6 to define the probing light, the light passing through the applied aperture indirectly defines the probing light. In the embodiment of FIG. 3, the probing volume 7 is optionally received by a multi-use cuvette (not shown). In such examples, the biological fluid analyser 1 may be configured as a multi-use device comprising the necessary fluidic system and mechanics (not shown) for conducted a plurality of measurements. Such example biological fluid analysers 1 may further comprise a solution pack comprising one or more solutions (not shown), which the example biological fluid analyser 1 is configured to administer and release by use of its fluidic system and mechanics to automatically at least partially prepare the prepared body fluid sample after aspiration, and is configured to control the fluidic system to perform a cleaning program of at least the multi-use cuvette prior and/or post biological fluid analysis

The incidence angle or angles of the probing light may be customised by the aperture device 5. In order to achieve such customisation, the system 1 comprises a controller 8 configured to control the aperture device 5.

The system 1 comprises a controller 8 configured to control parts of the imaging system 1. For example, the controller 8 may be configured to control the aperture device via one or more aperture control signals to the aperture device 5.

In FIG. 3, the aperture device 5 is controlled by the controller 8 according to an aperture configuration in which the applied aperture has a second aperture configuration. In other words, the controller has sent a second aperture control signal to the aperture device 5. As explained above, the second aperture configuration allows the light converging at the three converging points on the real focal plane of the first lens assembly 4 to pass through the applied aperture.

Since the aperture device 5 of this embodiment extends along the rear focal plane of the first lens assembly 4, the aperture device 5 may carry out a precise filtration of the light directed by the first lens assembly 4 by selectively applying the aperture to comprise one or more of the converging points located on the rear focal plane of the first lens assembly 4. However, the aperture device 5 may also extend along a plane different from the rear focal plane of the first lens assembly 4 and still carry out a suitable filtration of the light directed by the first lens assembly 4.

FIG. 4 shows a flow diagram of an exemplary method. A method 100 for classifying a cell in a prepared biological fluid sample, is illustrated. The method 100 may be performed by a biological fluid analyser as discloses herein, such as the biological fluid analyser BA of FIG. 1 and/or the biological fluid analyser 10 of FIG. 2. The method 100 comprising obtaining S102 image data, also denoted ID, of one or more images planes of an image stack in the prepared biological fluid sample. The image data ID comprises first image data ID_1 associated with a first image plane IP_1.

Obtaining S102 the first image data ID_1 comprises obtaining S102A first primary image data ID_1_1 of the first image plane IP_1. The first primary image data ID_1_1 is associated with a first incident light setting having a first angular light distribution. Obtaining S102 the first image data ID_1 comprises obtaining S102B first secondary image data ID_1_2 of the first image plane IP_1. The first secondary image data ID_1_2 is associated with a second incident light setting having a second angular light distribution.

The method 100 comprises classifying S108, based on the first primary image data ID_1_1 and/or the first secondary image data ID_1_2, a cell CE in the prepared biological fluid sample.

The method 100 comprises providing S110, based on the classification S108 of the cell CE, a cell parameter CP associated with the cell CE.

In one or more exemplary methods, obtaining S102 first image data ID_1 comprises obtaining S102C first tertiary image data ID_1_3 of the first image plane IP_1, wherein the first tertiary image data ID_1_2 is associated with a third incident light setting having a third angular light distribution.

In one or more exemplary methods, classifying S108 the cell CE is based on the first tertiary image data ID_1_3.

In one or more exemplary methods, the method 100 comprises determining S104, based on the image data ID, a set of cell regions SCR_i.

In one or more exemplary methods, determining S104 the set of cell regions SCR_i comprises determining S104A the set of cell regions SCR_i, such as first set of cell regions SCR_1, such as belonging to the first image plane IP_1, based on the first image data ID_1.

In one or more exemplary methods, classifying S108 the cell CE comprises classifying S108A a cell in a first cell region of the set of cell regions for provision S110A of a first cell parameter CP_1 indicative of a cell type of the cell.

In one or more exemplary methods, classifying S108 the cell CE comprises applying S108B a classification model to one or more of: the first primary image data ID_1_1, the first secondary image data ID_1_2, and the first tertiary image data ID_1_3.

In one or more exemplary methods, classifying S108 the cell CE comprises identifying S108C a cell type of the cell CE.

In one or more exemplary methods, obtaining S102 image data ID comprises obtaining S102D second image data ID_2 associated with a second image plane IP_2. In one or more exemplary methods, obtaining S102D second image data ID_2 comprises obtaining S102D1 second primary image data ID_2_1 of a second image plane IP_2 in the prepared biological fluid sample, the second primary image data ID_2_1 associated with the first incident light setting. In one or more exemplary methods, obtaining S102D second image data ID_2 comprises obtaining S102D2 second secondary image data ID_2_2 of a second image plane IP_2 in the prepared biological fluid sample, the second secondary image data ID_2_2 associated with the second incident light setting. In one or more exemplary methods, obtaining S102D second image data ID_2 comprises obtaining S102D3 second tertiary image data ID_2_3 of a second image plane IP_2 in the prepared biological fluid sample, the second tertiary image data ID_2_3 associated with the tertiary incident light setting.

In one or more exemplary methods, classifying S108 the cell CE comprises classifying S108D, based on one or more of the second primary image data ID_2_1 and the second secondary image data ID_2_2, a cell in the prepared biological fluid sample.

In one or more exemplary methods, determining S104 the set of cell regions SCR_i is based on the second image data ID_2.

In one or more exemplary methods, providing S110 a cell parameter CP comprises determining S110A, based on the first primary image data ID_1_1 and the first secondary image data ID_1_2, a cell parameter CP for a plurality of cell regions of the set of cell regions SCR_i, for providing a plurality of cell parameters CP_k_1.

In one or more exemplary methods, the method 100 comprises determining S112 a cell representation CP of the prepared biological fluid sample based on the cell parameter, such as based the plurality of first cell parameters CP_k_1.

In one or more exemplary methods, providing S110 a cell parameter CP is based on a cell feature indicative of one or more of: a lobe feature, an area feature, a contrast feature, a roundness feature, a granularity feature, a nucleus feature, an optical feature, and a function of one or more of the previous features.

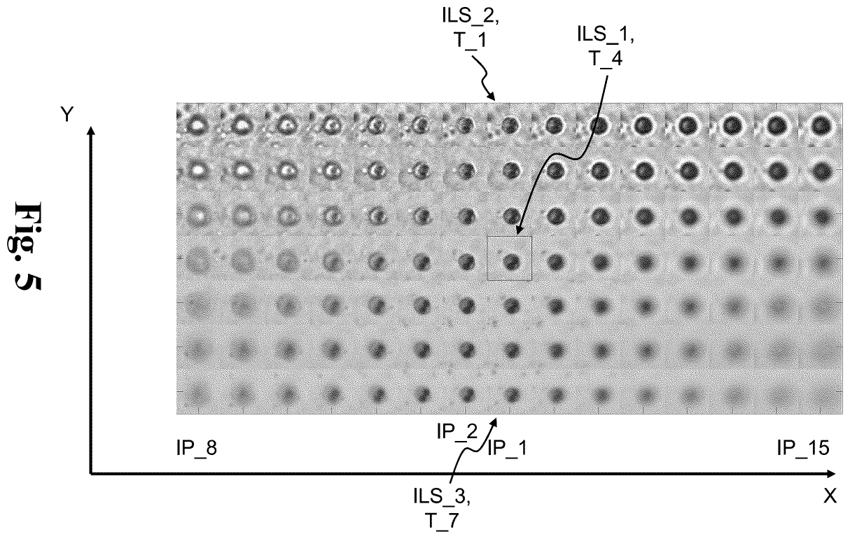

FIGS. 5-9 show exemplary images of cells (such as cell regions) obtained in different image planes (along an X-axis) and obtained with different incident light settings (along a Y-axis), where an exemplary method and/or biological fluid analyser according to the present disclosure are carried out and/or used, e.g., where a technique as disclosed herein is carried and/or used. FIGS. 5-9 each shows series of seven images, such as image tiles, for each of the fifteen image planes (IP_1 to IP_15), the image tiles comprising cell regions in fifteen different image planes and obtained with seven different incident light settings. The fourth tile T_4 in FIGS. 5-9 may be seen as the first primary image data ID_1_1 of the first image plane IP_1, obtained with a first incident light setting ILS_1 having a first angular light distribution ALD_1. The first tile T_1 in FIGS. 5-9 may be seen as the first secondary image data ID_1_2 of the first image plane IP_1, obtained with a second incident light ILS_2 setting having a second angular light distribution ALD_2. The seventh tile T_7 in FIGS. 5-9 may be seen as the first tertiary image data ID_1_3 of the first image plane IP_1, obtained with a third incident light ILS_3 setting having a third angular light distribution ALD_3.

The eleventh tile T_11 in FIGS. 5-9 may be seen as the second primary image data ID_2_1 of the second image plane IP_2, obtained with a first incident light setting ILS_1 having a first angular light distribution ALD_1. The eight tile T_8 in FIGS. 5-9 may be seen as the second secondary image data ID_2_2 of the second image plane IP_2, obtained with a second incident light ILS_2 setting having a second angular light distribution ALD_2. The fourteenth tile T_14 in FIGS. 5-9 may be seen as the second tertiary image data ID_2_3 of the second image plane IP_1, obtained with a third incident light ILS_3 setting having a third angular light distribution ALD_3.

FIG. 5 shows a series of seven images, such as image tiles, for each image plane comprising a cell region in fifteen different image planes with an interplane distance of about 5 μm. The cell observed in FIG. 5 has been classified to be an Eosinophil.

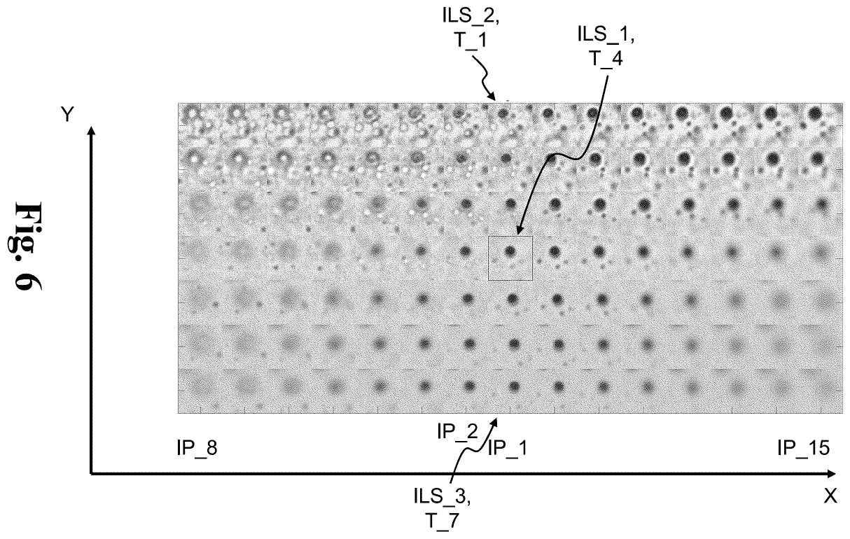

FIG. 6 shows a series of seven images, such as image tiles, for each image plane of an image stack, the seven images comprising a cell region in fifteen different image planes with an interplane distance of about 5 μm. The cell observed in FIG. 6 has been classified to be a Lymphocyte.

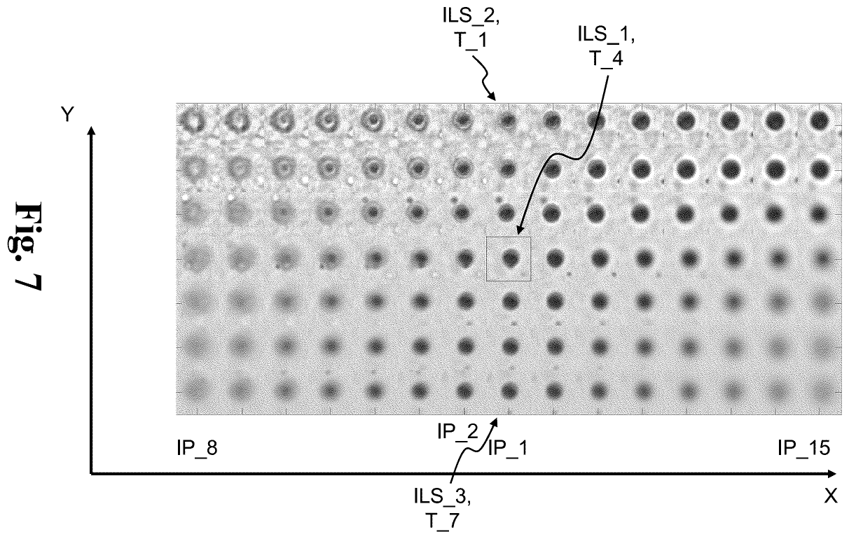

FIG. 7 shows a series of seven images, such as image tiles, for each image plane of an image stack, the seven images comprising a cell region in fifteen different image planes with an interplane distance of about 5 μm. The cell observed in FIG. 7 has been classified to be a Monocyte.

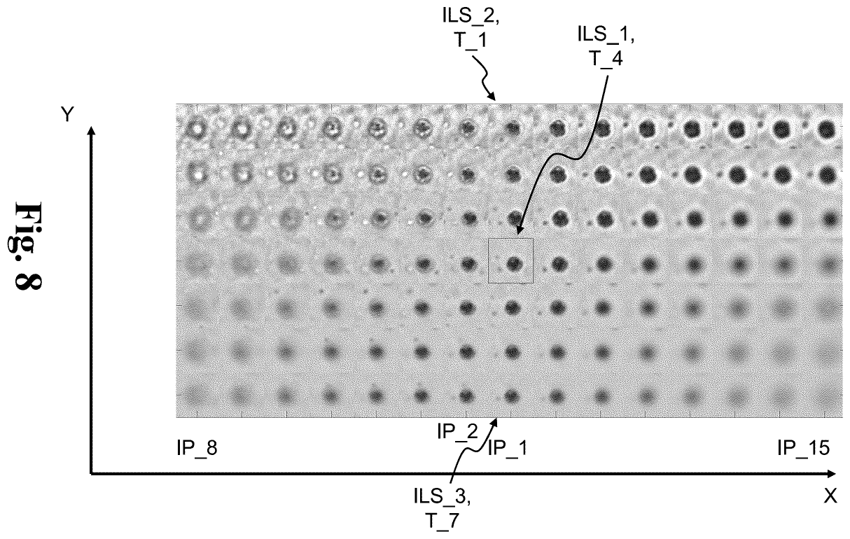

FIG. 8 shows a series of seven images, such as image tiles, for each image plane of an image stack, the seven images comprising a cell region in fifteen different image planes with an interplane distance of about 5 μm. The cell observed in FIG. 8 has been classified to be a Neutrophil.

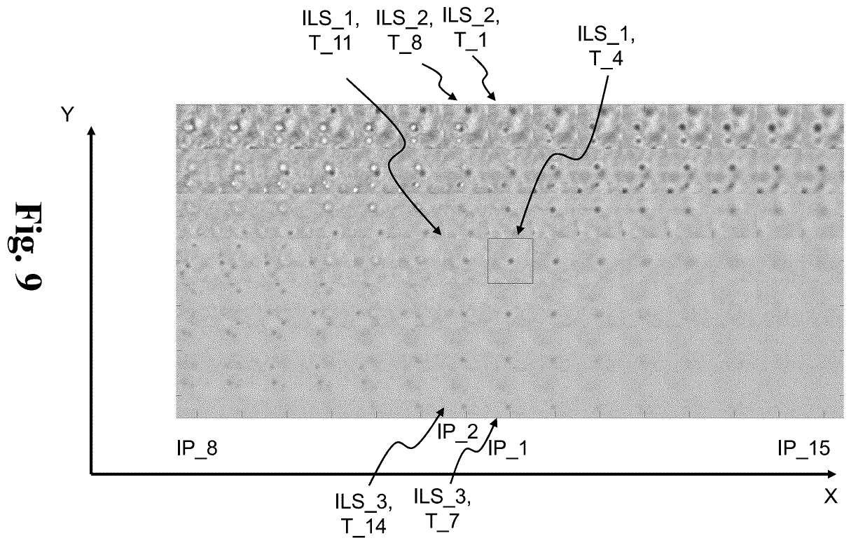

FIG. 9 shows a series of seven images, such as image tiles, for each image plane of an image stack, the seven images comprising a cell region in fifteen different image planes with an interplane distance of about 5 μm. The cell observed in FIG. 9 has been classified to be a Platelet.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering.

Memory may be one or more of a buffer, a flash memory, a hard drive, a removable media, a volatile memory, a non-volatile memory, a random access memory (RAM), or other suitable device. In a typical arrangement, memory may include a non-volatile memory for long term data storage and a volatile memory that functions as system memory for the processor. Memory may exchange data with processor over a data bus. Memory may be considered a non-transitory computer readable medium.

Memory may be configured to store information (such as information indicative of a cell parameter, image data, cell representation(s), and/or cell feature(s)) in a part of the memory.

Furthermore, the labelling of a first element does not imply the presence of a second element and vice versa.

It may be appreciated that FIGS. 1-9 comprise some modules or operations which are illustrated with a solid line and some modules or operations which are illustrated with a dashed line. The modules or operations which are comprised in a solid line are modules or operations which are comprised in the broadest example embodiment. The modules or operations which are comprised in a dashed line are example embodiments which may be comprised in, or a part of, or are further modules or operations which may be taken in addition to the modules or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

The various exemplary methods, devices, and systems described herein are described in the general context of method steps processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform specified tasks or implement specific abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications, and equivalents.

Examples of methods and products (biological fluid analyser and system) according to the disclosure are set out in the following items:
Item 1. A biological fluid analyser, the biological fluid analyser comprising a memory, an interface, and one or more processors, wherein the biological fluid analyser is configured to:
obtain image data of one or more images planes of an image stack in a prepared biological fluid sample, the image data comprising first image data associated with a first image plane, wherein to obtain first image data comprises to:
obtain first primary image data of the first image plane, wherein the first primary image data is associated with a first incident light setting having a first angular light distribution, and
obtain first secondary image data of the first image plane, wherein the first secondary image data is associated with a second incident light setting having a second angular light distribution; and
classify, based on the first primary image data and the first secondary image data, a cell in the prepared biological fluid sample for provision of a cell parameter associated with the cell.
Item 2. Biological fluid analyser according to item 1, wherein to obtain first image data comprises to obtain first tertiary image data of the first image plane, wherein the first tertiary image data is associated with a third incident light setting having a third angular light distribution, and wherein to classify a cell in the prepared biological fluid sample is based on the first tertiary image data.
Item 3. Biological fluid analyser according to any of the previous items, wherein the biological fluid analyser is configured to determine, based on the image data, a set of cell regions.
Item 4. Biological fluid analyser according to item 3, wherein to determine the set of cell regions is based on the first image data.
Item 5. Biological fluid analyser according to any of items 3-4, wherein to determine the set of cell regions comprises to determine a first set of cell regions belonging to the first image plane based on the first image data.
Item 6. Biological fluid analyser according to any of items 3-5, wherein to classify a cell in the prepared biological fluid sample comprises to classify a cell in a first cell region of the set of cell regions for provision of a first cell parameter indicative of a cell type of the cell.
Item 7. Biological fluid analyser according to any of the previous items, wherein to classify a cell in the prepared biological fluid sample comprises to apply a classification model to one or more of: the first primary image data, the first secondary image data, and the first tertiary image data.
Item 8. Biological fluid analyser according to any of the previous items, wherein to classify a cell in the prepared biological fluid sample comprises to identify a cell type of the cell.
Item 9. Biological fluid analyser according to any of the previous items, wherein the first incident light setting comprises one or more of: lens assembly settings, aperture settings, an angle setting, and light source settings, and wherein the first incident light setting is configured to provide incident light comprising a first light component with a first light angle larger than a first angle.
Item 10. Biological fluid analyser according to any of the previous items, wherein the first incident light setting comprises an aperture setting indicative of a first aperture size used for obtaining the first primary image data.
Item 11. Biological fluid analyser according to any of the previous items, wherein the second incident light setting comprises one or more of: lens assembly settings, aperture settings, an angle setting, and light source settings. and wherein the second incident light setting is configured to provide incident light comprising a second light component with a second light angle larger than a second angle.
Item 12. Biological fluid analyser according to any of the previous items, the second incident light setting is configured to provide incident light angles non-overlapping with incident light angles according to the first incident light setting.
Item 13. Biological fluid analyser according to any of the previous items, wherein the second incident light setting comprises an aperture setting indicative of a second aperture size used for obtaining the first secondary image data.
Item 14. Biological fluid analyser according to any of items 10-13, wherein the first aperture size is different from the second aperture size and/or wherein a shape of a first aperture is different from a shape of a second aperture.
Item 15. Biological fluid analyser according to any of the previous items, wherein the first incident light setting and/or the second incident light setting comprise an aperture setting indicative of a numerical aperture in the range from 0 to 0.7.
Item 16. Biological fluid analyser according to any of the previous items, wherein to obtain image data comprises to obtain second image data associated with a second image plane, wherein to obtain second image data comprises one or more of to:
obtain second primary image data of a second image plane in the prepared biological fluid sample, the second primary image data associated with the first incident light setting, and
obtain second secondary image data of the second image plane of the prepared biological fluid sample, the second secondary image data obtained with the second incident light setting; and wherein the biological fluid analyser is configured to:
classify, based on one or more of the second primary image data and the second secondary image data, a cell in the prepared biological fluid sample.
Item 17. Biological fluid analyser according to item 16 as dependent on item 3, wherein to determine the set of cell regions is based on the second image data.
Item 18. Biological fluid analyser according to any of the previous items, wherein to provide a cell parameter comprises to determine, based on the first primary image data and the first secondary image data, a cell parameter for a plurality of cell regions of the set of cell regions, for providing a plurality of cell parameters.
Item 19. Biological fluid analyser according to any of the previous items, wherein the biological fluid analyser is configured to determine, based on the cell parameter, a cell representation of the prepared biological fluid sample.
Item 20. Biological fluid analyser according to any of the previous items, wherein the provision of the cell parameter is based on a cell feature indicative of one or more of: a lobe feature, an area feature, a contrast feature, a roundness feature, a granularity feature, a nucleus feature, an optical feature, and a function of one or more of the previous features.
Item 21. Biological fluid analyser according to any of the previous items, wherein the first image data comprises first composite image data based on the first primary image data and/or the first secondary image data.
Item 22. A computer program product comprising a non-transitory computer readable medium, having thereon a computer program comprising program instructions, the computer program being loadable into a data processing unit and configured to cause execution of the operations according to any of items 1 through 21 when the computer program is run by the data processing unit.
Item 23. A method for classifying a cell in a prepared biological fluid sample, the method comprising:
   obtaining image data of one or more images planes of an image stack in the prepared biological fluid sample, the image data comprising first image data associated with a first image plane, wherein the obtaining of first image data comprises:
   obtaining first primary image data of the first image plane, wherein the first primary image data is associated with a first incident light setting having a first angular light distribution, and
   obtaining first secondary image data of the first image plane, wherein the first secondary image data obtained with a second incident light setting having a second angular light distribution;
   classifying, based on the first primary image data and the first secondary image data, a cell in the prepared biological fluid sample; and
   providing, based on the classification of the cell, a cell parameter associated with the cell.

### LIST OF REFERENCES

U user
200 system
1 imaging system
12 output
14 transmit/obtain
10 biological fluid analyser
10A memory
10B interface
10C processor
20 microscope
22 container/cuvette
24 central portion
302, 302A, 302B transmit
308 output
BA biological fluid analyser
PIP_i proximal image plane
PIP_1 first proximal image plane
IP_i image plane
IP_1 first image plane
IP_2 second image plane
DIP_i distal image plane
DIP_1 first distal image plane
PH_i proximal height
PH_1 first proximal height
H_i height
H_1 first height
H_2 second height
DH_i distal height
DH_1 first distal height
PD_i proximal distance
DD_i distal distance
PD_1 first proximal distance
DD_1 first distal distance
CE cell
Δz stepping incrimination
Z z-axis
ID image data
ID_1 first primary image data
I_i image
IM Image module
FEM feature extraction module
CCM classification circuitry module
PI_i proximal image
DI_i distal image
SCR_i set of cell regions
CR_k_i cell regions
CP_k_i cell parameter(s)
C_i number of cell regions
ID_1_1 first primary image data
ID_1_2 first secondary image data
ID_1_2 first tertiary image data
ID_2_1 second primary image data
ID_2_2 second secondary image data
ID_2_3 second tertiary image data
ILS incident light setting
ILS_1 first incident light setting
ILS_2 second incident light setting
ILS_3 third incident light setting
ALD angular light distribution
ALD_1 first angular light distribution
ALD_2 second angular light distribution
ALD_3 third angular light distribution
A angle
A_1 first angle
A_2 second angle
AS aperture size
AP_1 first aperture
AP_2 second aperture
AP_3 third aperture
AS_1 first aperture size
AS_2 second aperture size
LC light component
LC_1 first light component
LC_2 second light component
LC_3 third light component

1. A biological fluid analyzer, the biological fluid analyzer comprising a memory, an interface, and one or more processors, wherein the biological fluid analyzer is configured to:
obtain image data of one or more image planes of an image stack in a prepared biological fluid sample, the image data comprising first image data associated with a first image plane, wherein the biological fluid analyzer is configured to obtain first image data by:
obtaining first primary image data of the first image plane, wherein the first primary image data is associated with a first incident light setting having a first angular light distribution, and
obtaining first secondary image data of the first image plane, wherein the first secondary image data is associated with a second incident light setting having a second angular light distribution; and
classify, based on the first primary image data and the first secondary image data, a cell in the prepared biological fluid sample for provision of a cell parameter associated with the cell.

2. The biological fluid analyzer according to claim 1, wherein the biological fluid analyzer is further configured to obtain first image data by obtaining first tertiary image data of the first image plane, wherein the first tertiary image data is associated with a third incident light setting having a third angular light distribution, and wherein the biological fluid analyzer is further configured to classify the cell in the prepared biological fluid sample based on the first tertiary image data.

3. The biological fluid analyzer according to claim 1, wherein the biological fluid analyzer is configured to determine, based on the image data, a set of cell regions.

4. The biological fluid analyzer according to claim 3, wherein the biological fluid analyzer is further configured to determine the set of cell regions based on the first image data.

5. The biological fluid analyzer according to claim 1, wherein the biological fluid analyzer is further configured to determine the set of cell regions by determining a first set of cell regions belonging to the first image plane based on the first image data.

6. The biological fluid analyzer according to claim 1, wherein the biological fluid analyzer is further configured to classify a cell in the prepared biological fluid sample by classifying a cell in a first cell region of the set of cell regions for provision of a first cell parameter indicative of a cell type of the cell.

7. The biological fluid analyzer according to claim 1, wherein the biological fluid analyzer is further configured to classify a cell in the prepared biological fluid sample by applying a classification model to one or more of: the first primary image data, the first secondary image data, or the first tertiary image data.

8. The biological fluid analyzer according to claim 1, wherein the biological fluid analyzer is further configured to classify a cell in the prepared biological fluid sample by identifying a cell type of the cell.

9. The biological fluid analyzer according to claim 1, wherein the biological fluid analyzer is further configured to obtain image data by obtaining second image data associated with a second image plane, wherein the biological fluid analyzer is further configured to obtain second image data by performing one or more of:
obtaining second primary image data of a second image plane in the prepared biological fluid sample, the second primary image data associated with the first incident light setting, or
obtaining second secondary image data of the second image plane of the prepared biological fluid sample, the second secondary image data obtained with the second incident light setting; and
wherein the biological fluid analyzer is further configured to:
classify, based on one or more of the second primary image data and the second secondary image data, a cell in the prepared biological fluid sample.

10. The biological fluid analyzer according to claim 9, further comprising determining a set of cell regions based on the second image data.

11. The biological fluid analyzer according to claim 1, wherein the biological fluid analyzer is further configured to provide a cell parameter by determining, based on the first primary image data and the first secondary image data, a cell parameter for a plurality of cell regions of the set of cell regions, for providing a plurality of cell parameters.

12. The biological fluid analyzer according to claim 1, wherein the biological fluid analyzer is configured to determine, based on the cell parameter, a cell representation of the prepared biological fluid sample.

13. The biological fluid analyzer according to claim 1, wherein the provision of the cell parameter is based on a cell feature indicative of one or more of: a lobe feature, an area feature, a contrast feature, a roundness feature, a granularity feature, a nucleus feature, an optical feature, or a function of one or more of the previous features.

14. The biological fluid analyzer according to claim 1, wherein the first image data comprises first composite image data based on the first primary image data and/or the first secondary image data.

15. A computer program product comprising a non-transitory computer readable medium, having thereon a computer program comprising program instructions, the computer program being loadable into a data processing unit and configured to cause execution of the operations of the biological fluid analyzer according to claim 1 when the computer program is run by the data processing unit.

16. A method for classifying a cell in a prepared biological fluid sample, the method comprising:
obtaining image data of one or more images planes of an image stack in the prepared biological fluid sample, the image data comprising first image data associated with a first image plane, wherein the obtaining of first image data comprises:
obtaining first primary image data of the first image plane, wherein the first primary image data is associated with a first incident light setting having a first angular light distribution, and
obtaining first secondary image data of the first image plane, wherein the first secondary image data obtained with a second incident light setting having a second angular light distribution;
classifying, based on the first primary image data and the first secondary image data, a cell in the prepared biological fluid sample; and
providing, based on the classification of the cell, a cell parameter associated with the cell.
